(19) United States
(12) Patent Application Publication
(10) Pub. No.: US 2022/0198476 A1
(43) Pub. Date: Jun. 23, 2022

(54) SYSTEMS FOR IDENTIFYING THE ABILITY OF USERS TO FORECAST POPULARITY OF VARIOUS CONTENT ITEMS

(71) Applicants: Shr Jin Wei, Taipei (TW); Chih-Heng Chung, New Taipei City (TW)

(72) Inventors: Shr Jin Wei, Taipei (TW); Chih-Heng Chung, New Taipei City (TW)

(21) Appl. No.: 17/132,584

(22) Filed: Dec. 23, 2020

(51) Int. Cl. G06Q 30/02; G06Q 50/00; G06F 16/2457; G06F 17/18; A63F 13/79; H04L 29/08

(52) U.S. Cl. CPC G06Q 30/0201; G06Q 50/01; H04L 67/22; G06F 17/18; A63F 13/79; G06F 16/24578

(57) ABSTRACT

Exemplary data processing systems and computer implemented methods are disclosed for identifying the ability of users to forecast popularity of various content items. Exemplary systems and methods identify a time period for a contest over which users compete to identify popular content items; receive content item selections identifying content items selected by a user as potentially popular; track, over the time period, view counts for the content items identified by the content item selections; determine, for the time period, view count gain rates for the content items identified by the content item selections in dependence upon the view counts for those content items; determine, for each of the users, a user rank in dependence upon the view count gain rates for the content items selected by that user; and publish the user rank for at least one of the users.

### BACKGROUND OF THE INVENTION

The field of the invention is data processing systems, or, more specifically, systems for identifying the ability of users to forecast popularity of various content items. In recent years there has been a meteoric rise in the quantity of content available for people to consume online in the form of video, audio, or other content.

With all of this content available for consumption, content consumer often get lost in the choices available from current content delivery systems such as, for example YouTube, Youku, Vimeo, Metacafe, Vevo, Facebook, and Instagram TV.

To assist a consumer in deciding what content to consume, a consumer often relies on recommendations by trusted individuals or organizations with which that consumer has a connection. Such trusted individuals or organizations may be a friend that shares content with the consumer, an individual or organization that produces content that the consumer typically consumes, or an individual or organization that curates content produced by others that the consumer finds enjoyable.

Trusting certain individuals or organizations allows consumers to filter through the myriad of content options. Some individual or organizations, however, are better are curating content than others. Consumers often grow their network of individuals or organizations that they trust organically over time. Presently, there is not an adequate system for exposing consumers to new individuals or organizations that curate content that might be of interest to consumers. As such, there is a need for systems that help consumers identify the ability of various individuals or organizations to forecast popularity of various content items. Such systems would also be of benefit to advertisers because advertisers are also looking to find channels where individual consumers are attracted in which to advertise products and services.

### SUMMARY OF THE INVENTION

Systems for identifying the ability of users to forecast popularity of various content items according to the present invention are generally disclosed. Such systems include one or more processing units and a physical network interface coupled to the one or more processing units. Such systems also include a non-volatile memory coupled to the one or more processing units, the non-volatile memory containing a data structure and instructions. The one or more processing units are configured to cause execution of the instructions for carrying out: identifying a time period for a contest over which users compete to identify popular content items and receiving for each of the users one or more content item selections. Each of the content item selections identifies a content item selected by that user as potentially popular. The one or more processing units are also configured to cause execution of the instructions for carrying out: tracking, over the time period, a view count for the content item identified by each of the content item selections, determining, for the time period, a view count gain rate for the content item identified by each of the content item selections in dependence upon the view count for that content item, determining, for each of the users, a user rank in dependence upon the view count gain rate for the content item identified by each of the content item selections received for that user, and publishing the user rank for at least one of the users.

The one or more processing units may also be configured to cause execution of the instructions for carrying out: providing the users with multiple contests over multiple time periods and generating a user profile for each of the users participating in the multiple contests over the multiple time periods in dependence upon the user rank for that user in each of the contests in which that user participates.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for identifying the ability of users to forecast popularity of various content items according to embodiments of the present invention.

FIG. 2 sets forth a block diagram of automated computing machinery comprising an example of a data processing system useful in systems for identifying the ability of users to forecast popularity of various content items according to embodiments of the present invention.

FIG. 3 sets forth a flow chart illustrating operation of an exemplary method for identifying the ability of users to forecast popularity of various content items according to embodiments of the present invention.

FIG. 4 sets forth a flow chart illustrating another exemplary method for determining a user rank for each of the users according to embodiments of the present invention.

FIG. 5 sets forth a flow chart illustrating another exemplary method for determining a user rank for each of the users according to embodiments of the present invention.

FIG. 6 sets forth a flow chart illustrating another exemplary method for determining a user rank for each of the users according to embodiments of the present invention.

FIG. 7 sets forth a flow chart illustrating another exemplary method for determining a user rank for each of the users according to embodiments of the present invention.

FIG. 8 sets forth a flow chart illustrating another exemplary method for determining a user rank for each of the users according to embodiments of the present invention.

FIG. 9 sets forth a flow chart illustrating another exemplary method for determining a user rank for each of the users according to embodiments of the present invention.

FIG. 10 sets forth a flow chart illustrating another exemplary method for determining a user rank for each of the users according to embodiments of the present invention.

FIG. 11 sets forth a flow chart illustrating another exemplary method for receiving for each of the users one or more content item selections according to embodiments of the present invention.

FIG. 12 sets forth a flow chart illustrating an additional exemplary method for identifying the ability of users to forecast popularity of various content items according to embodiments of the present invention.

### DETAILED DESCRIPTION OF EXEMPLARY EMBODIMENTS

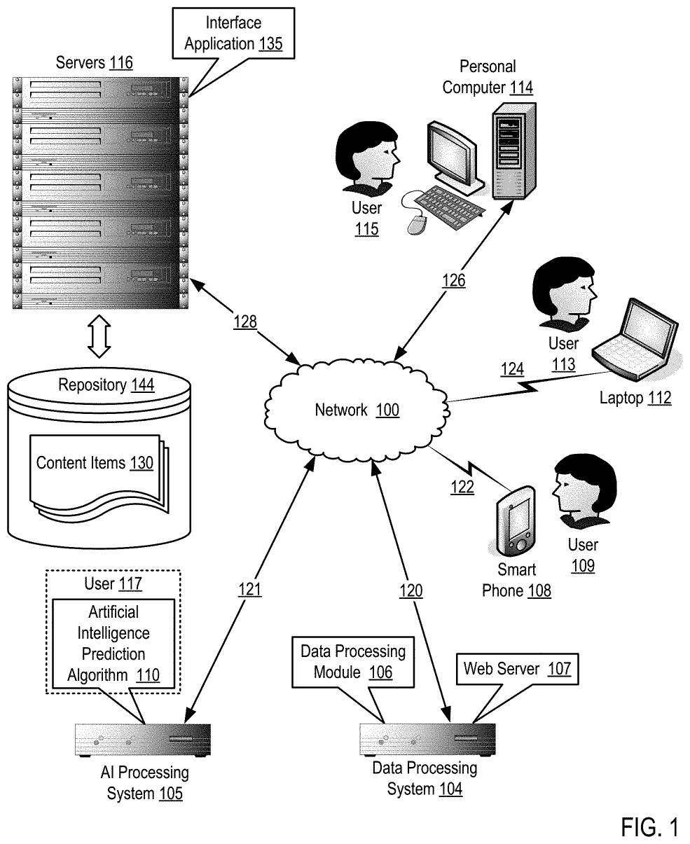

Exemplary systems for identifying the ability of users to forecast popularity of various content items according to embodiments of the present invention are described with reference to the accompanying drawings, beginning with FIG. 1. FIG. 1 sets forth a network diagram illustrating an exemplary system for identifying the ability of users to forecast popularity of various content items (130) according to embodiments of the present invention.

The content items (130) of FIG. 1 may include video content, audio content, image content, text content, or any other content capable of being curated for consumption by an audience content consumers. Exemplary content items may include YouTube videos, audio books, artwork, music tracts, short stories, and so on. Each time an audience member consumes a content item, that particular content item is referred to as ‘viewed’. Of course ‘viewed’ is broader than merely referring to the fact that an audience member looked at this content item with their eyes. Rather ‘viewed’ refers generally to accessing the content item in the manner it was intended to be consumed. For example, after an audience member listens to an audio track, that audio tract is considered to have been ‘viewed’, after an audience member watches a video, that video is considered to have been ‘viewed’, and so on.

Identifying the ability of users to forecast popularity of these various content items (130) according to embodiments of the present invention allows content consumers to track and follow users who have successfully forecast popular content items in the past. In this way, a user that ranks well for forecasting popular content items may develop trust with content consumers in that user's ability to pick quality content. Such a user might develop their own audience of content consumers that this user might then be able to monetize through advertising, affiliated marketing, selling branded merchandise, or any number of other monetization strategies applicable to such an audience.

The exemplary system of FIG. 1 includes a data processing system (104) connected to various other devices via network (100). A data processing system generally refers to automated computing machinery. The data processing system (104) of FIG. 1 useful in identifying the ability of users to forecast popularity of various content items according to embodiments of the present invention may be configured in a variety of form factors or implemented using a variety of technologies. Some data processing systems may be implemented using single-purpose computing machinery, such as special-purpose computers programmed only for the task of data processing for identifying the ability of users to forecast popularity of various content items according to embodiments of the present invention. Other data processing systems may be implemented using multi-purpose computing machinery, such as general purpose computers programmed for a variety of data processing functions in addition to identifying the ability of users to forecast popularity of various content items according to embodiments of the present invention. These multi-purpose computing devices may be implemented as portable computers, laptops, personal digital assistants, tablet computing devices, multi-functional portable phones, or the like.

In the example of FIG. 1, the data processing system (104) includes at least one processor, at least one memory, and at least one transceiver, all operatively connected together, typically through a communications bus. The transceiver is a network transmitter and receiver that connects the data processing system (104) to the network (100) through a wired connection (120). The transceiver may use a variety of technologies, alone or in combination, to establish wired connection (120) with network (100) including, for example, those technologies described by Institute of Electrical and Electronics Engineers (IEEE) 802.3 Ethernet standard, SynOptics LattisNet standard, 100BaseVG standard, Telecommunications Industry Association (TIA) 100BASE-SX standard, TIA 10BASE-FL standard, G.hn standard promulgated by the ITU Telecommunication Standardization Sector, or any other wired communications technology as will occur to those of skill in the art.

Non-volatile memory included in the data processing system (104) of FIG. 1 includes a data processing module (106) and web server (107). Non-volatile memory is computer memory that can retain the stored information even when no power is being supplied to the memory. The non-volatile memory may be part of the data processing system (104) of FIG. 1 or may be a separate storage device operatively coupled to the data processing system (104). Examples of non-volatile memory include flash memory, ferroelectric RAM, magnetoresistive RAM, hard disks, magnetic tape, optical discs, and others as will occur to those of skill in the art.

The data processing module (106) of FIG. 1 is a set of computer program instructions for identifying the ability of users to forecast popularity of various content items according to embodiments of the present invention. When processing the data processing module (106) of FIG. 1, a processor may operate the data processing system (104) of FIG. 1 to: identify a time period for a contest over which users (109, 113, 115, 117) compete to identify popular content items; receive for each of the users one or more content item selections, where each of the content item selections identifies a content item (130) selected by that user as potentially popular; track, over the time period, a view count for the content item (130) identified by each of the content item selections; determine, for the time period, a view count gain rate for the content item (130) identified by each of the content item selections in dependence upon the view count for that content item (130); determine, for each of the users, a user rank in dependence upon the view count gain rate for the content item identified by each of the content item selections received for that user; and publish the user rank for at least one of the users. The processor may further operate the data processing system (104) of FIG. 1 to provide the users with multiple contests over multiple time periods; and generating a user profile for each of the users participating in the multiple contests over the multiple time periods in dependence upon the user rank for that user in each of the contests in which that user participates.

In FIG. 1, the users include human users (109, 113, 115), but also includes a machine user (117). While human users (109, 113, 115) may use certain biological data processing mechanisms or impulses to forecast popularity of various content items, machine user (117) may utilize an artificial intelligence predictive algorithm (110) in an attempt to select content items that may become popular. Such an algorithm (110) may attempt to analyze various metrics of the content items (130) and compare those metrics to the metrics of prior popular content items in order to predict which of those content item (130) will become popular. Such metrics may vary depending on the type of content. For example, for video or image content, such metrics may be determined by image analysis techniques that include 2D and 3D object recognition, image segmentation, motion detection (e.g. single particle tracking), video tracking, optical flow, 3D Pose Estimation, and so on. Regardless of whether the users are human or machine, however, systems according to embodiments of the present invention may be useful for identifying the ability of those users to forecast popularity of various content items (130).

The web server (107) of FIG. 1 is software that serves web pages to and responds to requests from clients on the World Wide Web. A web server may process incoming network requests over Hypertext Transfer Protocol (HTTP) and several other related protocols. Clients typically include web browsers such as, for example, Google Chrome, Microsoft Edge, Internet Explorer, Safari, Mozilla Firefox, and well as others, but may also include any software programed to send requests using transfer protocols such as HTTP. The web server (107) of FIG. 1 accesses, processes, and delivers web pages to various clients operating on devices (108, 112, 114) connected via the network (100). The webpages delivered are most frequently HTML documents, which may include text, audio, images, video, style sheets, and scripts, but other formats will occur to those of skill in the art may also be used.

In the example of FIG. 1, the web server (107) is the interface through which users (109, 113, 115, and 117) interact with data processing module (106). Human users (109, 113, 115) of FIG. 1, may interact with data processing module (106) through webpages served up by web server (107). Machine user (117) in the example of FIG. 1 may interact with data processing module (106) through an application programming interface (API) exposed by the web server (107) to the network (100). This API may be implemented using Representational State Transfer (REST), Simple Object Access Protocol (SOAP), Rich client platform (RCP), or other architectures as will occur to those of skill in the art.

For example, after viewing various content items (130), human users (109, 113, 155) may provide data processing module (106) one or more content item selections that the user believes will be a popular content item by selecting certain content items (130) listed on a webpage served up by the web server (107). After the contest has completed, the web server (107) of FIG. 1 may publish a ranking for the users that participated in the contest that inform how the users performed relative to one another at forecasting popular content items. Machine user (117), in turn, may make a request through a REST API exposed by web server (107) that provides data processing module (106) one or more content item selections that the user (117) predicts will be a popular. After the contest is over, the machine user (117) may make a request through a REST API exposed by web server (107) that provides the ranking for the users that participated in the contest.

Because the data processing system (104) of FIG. 1 is connected to the network (100), the data processing system (104) of FIG. 1 may communicate with other devices connected to the network (100). In the example of FIG. 1, for example, smart phone (108) operated by user (109) connects to the network (100) via wireless connection (122), laptop (112) operated by user (113) connects to network (100) via wireless connection (124), personal computer (114) operated by user (115) connects to network (100) through wireline connection (126), artificial intelligence processing system (105) running artificial intelligence prediction algorithm (110) connects to network (100) via wireline connection (121), and servers (116) connect to network (100) through wireline connection (128).

The wireless connections (122, 124) of Figure may be implemented using many different technologies. For example, useful technologies for with exemplary embodiments of the present invention may include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology.

In the example of FIG. 1, servers (116) host a repository (144) of information that may be useful in systems for identifying the ability of users to forecast popularity of various content items according to embodiments of the present invention. Repository (144) of FIG. 1 stores content items (130), and those content items (130) are operatively coupled to the interface application (135). The repository (144) may be implemented as a database stored locally on the servers (116) or remotely stored and accessed through a network. The interface application (135) may be operatively coupled to such an exemplary repository through an application programming interface (‘API’) exposed by a database management system (‘DBMS’) such as, for example, an API provided by the Open Database Connectivity (‘ODBC’) specification, the Java database connectivity (‘JDBC’) specification, and so on.

The content items (130) of FIG. 1 may be stored in the repository (144) in a variety of formats. Image formats that may be useful in systems for identifying the ability of users to forecast popularity of various content items according to embodiments of the present invention may include JPEG (Joint Photographic Experts Group), JFIF (JPEG File Interchange Format), JPEG 2000, Exif (Exchangeable image file format), TIFF (Tagged Image File Format), RAW, PNG (Portable Network Graphics), GIF (Graphics Interchange Format), BMP (Bitmap), PPM (Portable Pixmap), PGM (Portable Graymap), PBM (Portable Bitmap), PNM (Portable Any Map), WEBP (Google's lossy compression image format based on VP8's intra-frame coding and uses a container based on RIFF), CGM (Computer Graphics Metafile), Gerber Format (RS-274X), SVG (Scalable Vector Graphics), PNS (PNG Stereo), and JPS (JPEG Stereo), or any other image format as will occur to those of skill in the art. Similarly, video formats that may be useful in systems for identifying the ability of users to forecast popularity of various content items according to embodiments of the present invention may include MPEG (Moving Picture Experts Group), H.264, WMV (Windows Media Video), Schrödinger, dirac-research, VPx series of formats developed by On2 Technologies, RealVideo), or any other format format as will occur to those of skill in the art. Some stand-alone audio formats that may be useful in systems for identifying the ability of users to forecast popularity of various content items according to embodiments of the present invention may include AIFF (Audio Interchange File Format), WAV (Microsoft WAVE), ALAC (Apple Lossless Audio Codec), MPEG (Moving Picture Experts Group), FLAC (Free Lossless Audio Codec), RealAudio, G.719, G.722, WMA (Windows Media Audio), and these codecs especially suitable for capturing speech, AMBE (Advanced Multi-Band Excitation), ACELP (Algebraic Code Excited Linear Prediction), DSS (Digital Speech Standard), G.711, G.718, G.726, G.728, G.729, HVXC (Harmonic Vector Excitation Coding), Truespeech, or any other audio format as will occur to those of skill in the art.

The data processing system (104) and the users (109, 113, 155, 117) of FIG. 1, in turn, access the content items (130) through interface application (135). The interface application (135) of FIG. 1 may provide an interface description of the web services publication interface by publishing the web services publication interface description in a Universal Description, Discovery and Integration (‘UDDI’) registry hosted by a UDDI server. A UDDI registry is a platform-independent, XML-based registry for organizations worldwide to list themselves on the Internet. UDDI is an open industry initiative promulgated by the Organization for the Advancement of Structured Information Standards (‘OASIS’), enabling organizations to publish service listings, discover each other, and define how the services or software applications interact over the Internet. The UDDI registry is designed to be interrogated by SOAP messages and to provide access to Web Services Description Language (‘IA/SDL’) documents describing the protocol bindings and message formats required to interact with a web service listed in the UDDI registry. In this manner, the data processing system (104) of FIG. 1 may retrieve the web services publication interface description for the content items (130) from the UDDI registry on servers (116). The term ‘SOAP’ refers to a protocol promulgated by the World Wide Web Consortium (′IA/3C′) for exchanging XML-based messages over computer networks, typically using Hypertext Transfer Protocol (‘HTTP’) or Secure HTTP (‘HTTPS’).

In the example of FIG. 1, the web services publication interface description utilized by the interface application (135) of FIG. 1 may be implemented as a Web Services Description Language (‘IA/SDL’) document. The WSDL specification provides a model for describing a web service's interface as collections of network endpoints, or ports. A port is defined by associating a network address with a reusable binding, and a collection of ports define a service. Messages in a WSDL document are abstract descriptions of the data being exchanged, and port types are abstract collections of supported operations. The concrete protocol and data format specifications for a particular port type constitutes a reusable binding, where the messages and operations are then bound to a concrete network protocol and message format. In such a manner, the data processing system (104) or other similar systems may utilize the web services publication interface description (134) to invoke the publication service provided by the interface application (135), typically by exchanging SOAP messages with the interface application (135). Of course, protocols other than SOAP may also be implemented such as, for example, REST message protocols, JavaScript Object Notation (JSON) protocols, and the like. The interface application (135) of FIG. 1 may be implemented using Java, C, C++, C#, Perl, or any other programming language as will occur to those of skill in the art.

In the example of FIG. 1, all of the servers and devices are connected together through a communications network (100), which in turn may be composed of many different networks. These different networks may be packet switched networks or circuit switched networks, or a combination thereof, and may be implemented using wired, wireless, optical, magnetic connections, or using other mediums as will occur to those of skill in the art. Typically, circuit switch networks connect to packet switch networks through gateways that provide translation between protocols used in the circuit switch network such as, for example, PSTN-V5 and protocols used in the packet switch networks such as, for example, SIP.

The packet switched networks, which may be used to implement network (100) in FIG. 1, are composed of a plurality of computers that function as data communications routers, switches, or gateways connected for data communications with packet switching protocols. Such packet switched networks may be implemented with optical connections, wireline connections, or with wireless connections or other such connections as will occur to those of skill in the art. Such a data communications network may include intranets, internets, local area data communications networks (‘LANs’), and wide area data communications networks (‘WANs’). Such packet switched networks may implement, for example:
a link layer with the Ethernet™ Protocol or the Wireless Ethernet™ Protocol,
a data communications network layer with the Internet Protocol (In,
a transport layer with the Transmission Control Protocol (‘TCP’) or the User Datagram Protocol (‘UDP’),
an application layer with the HyperText Transfer Protocol (‘HTTP’), the Session Initiation Protocol (‘SIP’), the Real Time Protocol (‘RTP’), the Distributed Multimodal Synchronization Protocol (‘DMSP’), the Wireless Access Protocol (‘WAP’), the Handheld Device Transfer Protocol (‘HDTP’), the ITU protocol known as H.323, and
other protocols as will occur to those of skill in the art.

The circuit switched networks, which may be used to implement network (100) in FIG. 1, are composed of a plurality of devices that function as exchange components, switches, antennas, base stations components, and connected for communications in a circuit switched network. Such circuit switched networks may be implemented with optical connections, wireline connections, or with wireless connections. Such circuit switched networks may implement the V5.1 and V5.2 protocols along with other as will occur to those of skill in the art.

The arrangement of the devices (104, 105, 108, 112, 114, 116) and the network (100) making up the exemplary system illustrated in FIG. 1 are for explanation, not for limitation. Systems useful for system for identifying the ability of users to forecast popularity of various content items according to various embodiments of the present invention may include additional networks, servers, routers, switches, gateways, other devices, and peer-to-peer architectures or others, not shown in FIG. 1, as will occur to those of skill in the art. Networks in such data processing systems may support many protocols in addition to those noted above. Various embodiments of the present invention may be implemented on a variety of hardware platforms in addition to those illustrated in FIG. 1.

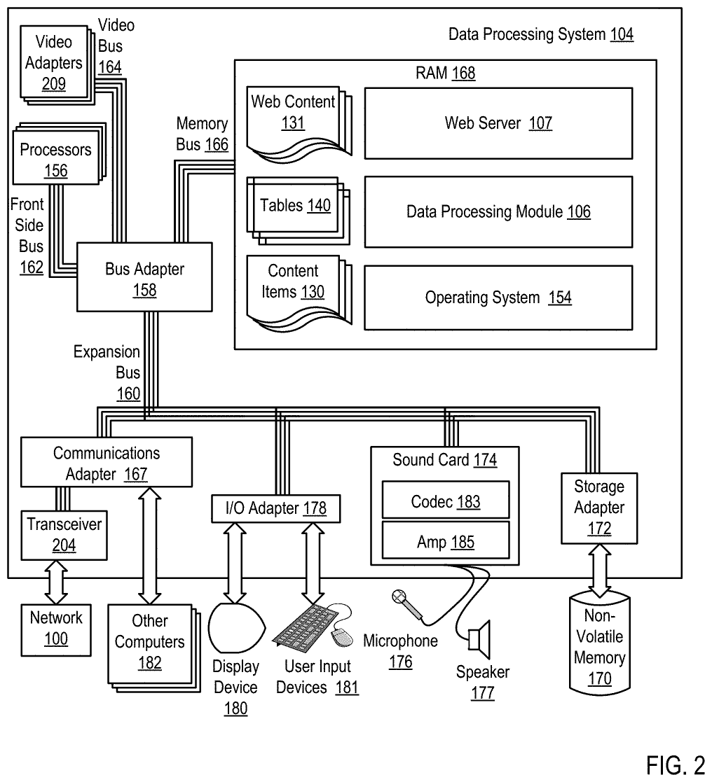

For further explanation, therefore, FIG. 2 sets forth a block diagram of automated computing machinery comprising an example of a data processing system (104) for use in an exemplary system for identifying the ability of users to forecast popularity of various content items according to embodiments of the present invention. The data processing system (104) of FIG. 2 includes at least one processor (156) or ‘CPU’ as well as random access memory (168) (‘RAM’) which is connected through a high speed memory bus (166) and bus adapter (158) to processor (156) and to other components of the data processing system (104).

Stored in RAM (168) of FIG. 2 is a data processing module (106) that is a set of computer programs that identify the ability of users to forecast popularity of various content items according to embodiments of the present invention. The data processing module (106) of FIG. 2 operates in a manner similar to the manner described with reference to FIG. 1. In at least one exemplary configuration, the data processing module (106) of FIG. 2 instructs the processor (156) of the data processing system (104) to: identify a time period for a contest over which users compete to identify popular content items (130); receive for each of the users one or more content item selections, where each of the content item selections identifies a content item (130) selected by that user as potentially popular; track, over the time period, a view count for the content item (130) identified by each of the content item selections; determine, for the time period, a view count gain rate for the content item (130) identified by each of the content item selections in dependence upon the view count for that content item (130); determine, for each of the users, a user rank in dependence upon the view count gain rate for the content item identified by each of the content item selections received for that user; and publish the user rank for at least one of the users.

Still further, the data processing module (106) of FIG. 2 also has a set of instructions to direct the processors (156) of the data processing system (104) to: provide the users with multiple contests over multiple time periods; and generating a user profile for each of the users participating in the multiple contests over the multiple time periods in dependence upon the user rank for that user in each of the contests in which that user participates.

Also stored in RAM (168) of FIG. 2 are tables (140), content items (130), web server (107), and web content (131). The tables (140) in FIG. 2 are data structures used by the data processing module (106) to store various information such as, for example, users' content item selections, view count gain rates for various content items, user ranks, user profiles, along with other calculations made by the processors (156) while executing the instructions of the data processing module (106) in accordance with embodiments of the present invention. These tables (140) may be implemented as a part of a database accessible to the data processing module (106) or as part of a file structure controlled directly by the data processing module (106).

The content items (130) of FIG. 2 are local copies of various content items (130) stored in the repository (144 on FIG. 1). The data processing system (104) would have retrieved those through the transceiver (204) that connects the data processing system (104) to the network (100).

The web server (107) of FIG. 2 serves up web content (131) based on requests received from other devices connected the network (100). The web content (131) of FIG. 2 may be implemented as web pages stored statically or created dynamically. In the example of FIG. 2, the web content (131) may be a webpage whereby a user selects various content items (130) that the user forecasts will be popular at the beginning of a contest and may be a webpage that publishes each user's ranking relative to all contest participants at the end of the contest.

Also stored in RAM (168) is an operating system (154). Operating systems useful in voice servers according to embodiments of the present invention include UNIX™, Linux™, Microsoft Windows™, IBM's AIX™, IBM's i5/OS™, Google™ Android™, Google™ Chrome OS™, Apple™ Mac™ OS, and others as will occur to those of skill in the art. Operating system (154), tables (140), content items (130), web server (107), web content (131), and the data processing module (106) in the example of FIG. 2 are shown in RAM (168), but many components of such software typically are stored in other secondary storage or other non-volatile memory storage, for example, on a flash drive, optical drive, disk drive, or the like.

The data processing system (104) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in a data processing system according to embodiments of the present invention include the Intel Northbridge, the Intel Memory Controller Hub, the Intel Southbridge, and the Intel I/O Controller Hub. Examples of expansion buses useful in data processing systems according to embodiments of the present invention include Peripheral Component Interconnect (‘PCP’) and PCI-Extended (‘PCI-X’) bus, as well as PCI Express (‘PCIe’) point to point expansion architectures and others.

The data processing system (104) of FIG. 2 includes storage adapter (172) coupled through expansion bus (160) and bus adapter (158) to processor (156) and other components of the data processing system (104). Storage adapter (172) connects non-volatile memory (170) to the data processing system (104). Storage adapters useful in data processing systems according to embodiments of the present invention include Integrated Drive Electronics (IDE′) adapters, Small Computer System Interface (‘SCSI’) adapters, Universal Serial Bus (‘USB’) and others as will occur to those of skill in the art. In addition, non-volatile computer memory may be implemented for an data processing system as an optical disk drive, electrically erasable programmable read-only memory (so-called ‘EEPROM’ or ‘Flash’ memory), RAM drives, and so on, as will occur to those of skill in the art.

The example data processing system (104) of FIG. 2 includes a sound card (174) to control input from a microphone (176) and output to a speaker (177). The sound card (174) decodes and encodes electromagnetic representations of sound between digital and analogue formats using codecs (183). The analogue electromagnetic representations of sound are amplified by the amplifier (185) configured in the sound card (174).

The example data processing system (104) of FIG. 2 includes one or more input/output (‘I/O’) adapters (178). I/O adapters in data processing systems implement user-oriented input/output through, for example, software drivers and computer hardware for controlling output to display devices such as computer display device (180), as well as user input from user input devices (181) such as keyboards and mice. The example data processing system of FIG. 2 also includes a video adapter (209), which is an example of an I/O adapter specially designed for graphics processing for the data processing system (104) useful for controlling higher-end video monitors and/or video input devices. Video adapter (209) is connected to processor (156) through a high speed video bus (164), bus adapter (158), and the front side bus (162), which is also a high speed bus.

The exemplary data processing system (104) of FIG. 2 includes a communications adapter (167) for data communications with other computer (182) and for data communications with a data communications network (100) through a transceiver (204). Such data communications may be carried out serially through RS-232 connections with other computers, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for in various embodiments of the present invention include modems for wired dial-up communications, Ethernet (IEEE 802.3) adapters for wired data communications network communications, and 802.11 adapters for wireless data communications network communications. The transceiver (204) may be implemented using use a variety of technologies, alone or in combination, to establish wireline or wireless communication with network (100) including, for example, Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA), Integrated Digital Enhanced Network (iDEN), IEEE 802.11 technology, Bluetooth, WiGig, WiMax, Iridium satellite communications technology, Globalstar satellite communications technology, or any other wireless communications technology as will occur to those of skill in the art.

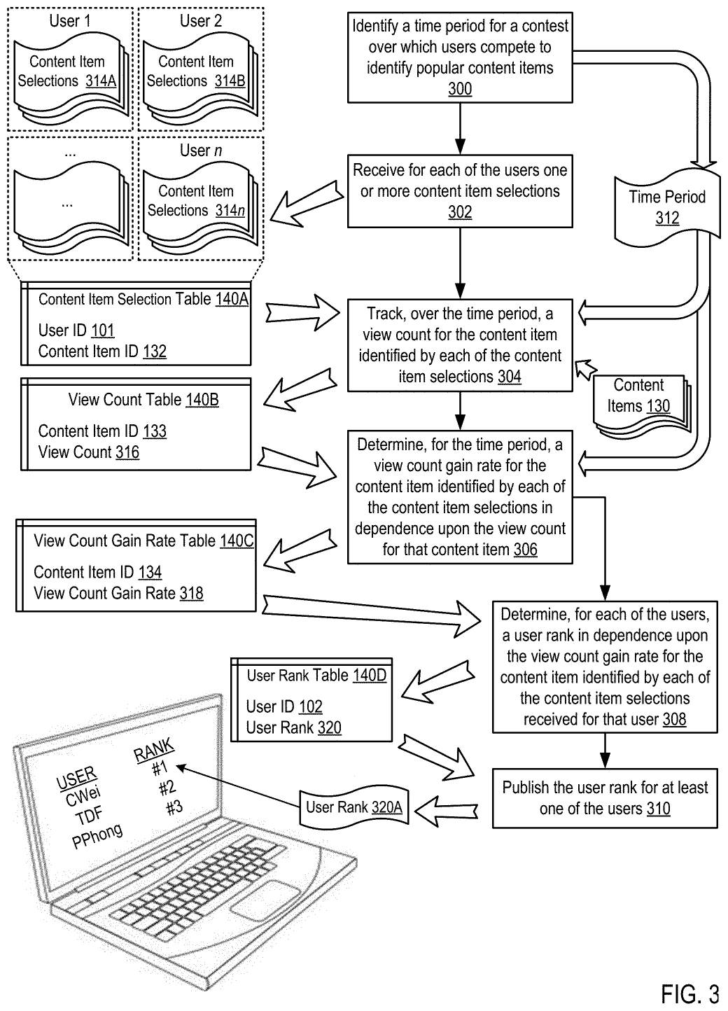

For further explanation, FIG. 3 sets forth a flow chart illustrating an exemplary method for identifying the ability of users to forecast popularity of various content items according to embodiments of the present invention. The exemplary method of FIG. 3 operates on a data processing system that includes one or more processing units, a physical network interface coupled to the one or more processing units, and a non-volatile memory coupled to the one or more processing units. The non-volatile memory contains data structures and instructions that, when executed by a processing unit, carry out the steps shown in the example of FIG. 3.

In the example of FIG. 3, a data processing unit identifies (300) a time period (312) for a contest over which users compete to identify popular content items. The time period (312) of FIG. 3 provides a window of time long enough to let each user's predictions play out and determine how accurate each user's forecast was for contest. The time period (312) of FIG. 3 is set by the administrator and/or sponsor of the contest and would typically be stored as an application variable or as a parameter for a particular contest. In some embodiments, the time period (312) may be a default setting but would be customizable for different contests. Because the time period (312) is used to set a beginning and ending time of a contest that occurs in the real world with human users, the time period (312) would typically be expressed in a way that could be translated to time on a calendar. The time period (312) in the example of FIG. 3, therefore, could be expressed in terms of a calendar start date and a calendar end date, a calendar start date and duration, or a duration and a calendar end date. Of course, the beginning and ending of the time period (312) of FIG. 3 does not have to coincide with the beginning or end of a particular calendar day. A time of day may also be incorporated into the time period (312) in the example of FIG. 3 when the time period for the contest begins at a time other than the beginning or end of a day. While the time period (312) of FIG. 3 marks the beginning and end of the contest described with reference to FIG. 3, readers of skill in the art will recognize that multiple contests could be occurring during any given time period, and the time periods for each of the contest could coincide and/or overlap. Examples of time periods useful in accordance with embodiments of the present invention may include but not be limited to one (1) week, one (1) month, three (3) months, etc.

In the example of FIG. 3, the data processing system receives (302) one or more content item selections (314) for each of the users participating in the contest. Each of the content item selections (314) of FIG. 3 identifies a content item (130) selected by a user as potentially popular. In the example of FIG. 3, ‘User 1’ provides content item selections (314A), ‘User 2’ provides content item selections (314B), . . . , and ‘User n’ provides content item selections (314n). Content item selections (314) of FIG. 3 are stored in a content item selection table (140A), which is one of the tables (140) described with reference to FIG. 2. The content item selection table (140A) of FIG. 3 includes two fields: user ID (101) and content item ID (132). In the example of FIG. 3, user ID (101) stores a unique identifier for one of the users participating in the contest to forecast popular content items. Content item ID (132) of FIG. 3 stores a unique identifier for a particular content item. Each row of the content item selection table (140A) of FIG. 3 represents a content item that a user selected as being a potentially popular content item. The content item is represented in the table (140A) by the unique identifier stored in the content item ID (132) field and the user that selected the content item is represented by the unique identifier for that user stored in the user ID (101) field.

The data processing system may receive (302) the content items selections (314) in the example of FIG. 3 in a variety of ways. The data processing system may receive (302) the content items selections (314) by publishing a webpage to which users could navigate to through the world wide web and enter their selections. In such exemplary embodiments, receiving (302) the content item selections (314) may include providing users with a predetermined set of content items from which users may select the ones that the users think will become the most popular, and/or allowing users to submit selections for content items not already predetermined by the contest administrator or sponsor. In these cases, receiving (302) the content item selections (314) in FIG. 3 may include receiving a message that contains a list of the user's content item selections (314) from a web server, which in turn received it as part of a HTTP transmission from a web browser operating on the user's computing device. The HTTP transmission may have originated when a user submitted the user's content item selections (314) on a web form on the contest website. In other embodiments, receiving (302) the content item selections (314) may occur by receiving and parsing a structured document such as, for example, an XML document that contains the user's content item selections (314). A user may electronically transmit such a structured document to the data processing system via, for example, an email or through FTP site.

In the example of FIG. 3, the data processing system tracks (304), over the time period (312) for the contest, a view count (316) for the content item (130) identified by each of the content item selections (314). The view count (316) of FIG. 3 represents the number of times that a member of the content audience has consumed or taken in that particular content item. The manner in which audience consumption is tracked may vary from one embodiment to another. For example, for video content, a particular video might be considered consumed in one embodiment when an audience member clicks ‘play’ on the video. In other embodiments, to filter out audience members casually cycling through videos, a particular video might not be considered consumed until the video has played for at least ten (10) seconds. In some other embodiments, a particular video might not be considered consumed unless the user indicates that the user ‘liked’ the video by clicking on a ‘like’ user interface element. In most embodiments of the present invention, using the same protocol across all of the content items being tracked for determining when each particular content item is consumed is advantageous so that view count (316) for each content item (130) reflects the same type of audience viewing behavior and does not skew the results. If different protocols are used, audience views determined by different methods may be adjusted based on the different measurement methodologies. Because content providers will likely be tracking how many views each particular content item on their platform receives, limiting the content items tracked in a particular contest to be sourced from the same content provider may help reduce the chances that views for different content items were counted differently between content items. For example, limiting the content items for a contest to only YouTube videos may help ensure that views for all of the videos are determined in the same manner.

In FIG. 3, tracking (304) a view count (316) for the content item (130) identified by each of the content item selections (314) may be carried out by requesting the view count for a content item at the beginning of the time period (312) from the content provider, requesting the view count that same content item at the end of the time period (312) from the content provider, and calculating the difference between the view count at the beginning of the time period (312) and the view count at the end of the time period (312) as the view count (316) for the time period (312)—this being done repeatedly at the beginning and end of the time period (312) for each of the content items identified in the content item selection table (140A). For an example of calculating the difference between the view count at the beginning of the time period (312) and the view count at the end of the time period (312) as the view count (316) for the time period (312), consider an exemplary time period of one (1) week. If the view count for a video at the beginning of the week is 10,000 views and the view count for a video at the end of the week is 25,000 views, then the view count for the week would be 15,000 (25,000 minus 10,000) views. Of course, sampling of the view count for content items may also be performed during the time period (312) in some embodiments. Such intra time period tracking of the view counts could allow for continuous tracking of view count gain rates and provide the ability to rank users in real time.

Requesting the view count from the content provider in many exemplary embodiments may be accomplished through an API exposed by the content provider. For example, to obtain the view count for a YouTube video, Google exposes an API through which the data processing system can request a JSON object for the video that contains certain statistics for the video including the view count. In this example, requesting the view count from the content provider may be carried out by executing the following pseudo code:

```
function youtube_view_count_shortcode($params)
{
  $videoID = $params[‘id’]; // view id here
  $json =
  file_get_contents(“https://www.googleapis.com/youtube/v3/videos?
  part=statistics&id=” . $videoID . “&key=googleapikey”);
  $jsonData = json_decode($json);
  $views = $jsonData−>items[0]−>statistics−>viewCount;
  return number_format($views);
}.
```

The view counts tracked over the time period (312) for each content item (130) are stored in a view count table (140B), which is one of the tables (140) described with reference to FIG. 2. The view count table (140B) of FIG. 3 has two fields: content item ID (133) and view count (316). Content item ID (133) stores a unique identifier for a particular content item. View count (316) stores the view count tracked for a particular content item over the time period (312). Each row in the view count table (140B) represents the view count tracked for a particular content item over the time period (312). The content item is represented in the table (140B) by the unique identifier stored in the content item ID (133) field and view count tracked for that content item over the time period (312) is then stored in the view count (316) field.

In the example of FIG. 3, the data processing system then determines (306), for the time period (312), a view count gain rate (318) for the content item (130) identified by each of the content item selections (314) in dependence upon the view count (316) for that content item (130). The view count gain rate (318) of FIG. 3 for a content item represents the average number of times that the content item was consumed over each of the units used to express the time period.

In the example of FIG. 3, determining (306), for the time period (312), a view count gain rate (318) for the content item (130) may be carried out by dividing the view count for that content item occurring over the time period (312) by the duration of the time period (312)—this being done repeatedly for each of the content items identified in the view count table (140B). Going back to our previous example where the exemplary time period was one (1) week—or seven (7) days—and the view count for the video over those 7 days was 15,000 views. In this example, the view count gain rate would be calculated as follows:

$$\frac{\text{15,000} views}{7 days} \approx \text{2,142.86} \frac{views}{day}$$

The view count gain rate (318) of FIG. 3 for each content item is stored in the view count gain rate table (140C), which is one of the tables (140) described with reference to FIG. 2. The view count gain rate table (140C) of FIG. 3 has two fields: content item ID (134) and view count gain rate (318). Content item ID (134) stores a unique identifier for a particular content item. View count gain rate (318) stores the view count gain rate determined for a particular content item over the time period (312). Thus, each row in the view count gain rate (318) represents the view count gain rate determined for a particular content item over the time period (312). The content item is represented in the table (140C) by the unique identifier stored in the content item ID (134) field and view count gain rate determined for that content item over the time period (312) is then stored in view count gain rate (318) field.

In the example of FIG. 3, the data processing system then determines (308), for each of the users, a user rank (320) in dependence upon the view count gain rate (318) for the content item identified by each of the content item selections (314) received for that user. The user rank (320) of FIG. 3 represents the performance of a particular user relative to other users participating in the contest and may be expressed in a variety of ways including but not limited to raw data calculations or ordinal numbers determined by a comparison of raw data calculations. For example, consider the following view count gain rates for three different users:

TABLE 1

| User | View Count Gain Rate |
|---|---|
| PPhong | 1,318.12 views/day |
| CWei | 3,347.93 views/day |
| TDF | 2,142.86 views/day |

The user rank for each of the users in Table 1 may be simply be a listing of the view count gain rate of each user such that the highest ranked user is the user having the highest view count gain rate. In other embodiments, however, user rank for each of the users in Table 1 may be expressed using ordinal numbers that are determined from the view count gain rate of each user such that the user with the highest view count gain rate is assigned the user rank of 1, the second highest view count gain rate is assigned the user rank of 2, and the third highest view count gain rate is assigned the user rank of 3. Continuing with the example above, the user rank would be assigned as follows:

TABLE 2

| User | User Rank |
|---|---|
| PPhong | 3 |
| CWei | 1 |
| TDF | 2 |

In the example of FIG. 3, therefore, determining (308), for each of the users, a user rank (320) in dependence upon the view count gain rate (318) for the content items selected by that user may be carried out by scanning all of the view count gain rates for the highest value, assigning the user that selected that content item with the highest view count gain rates the ordinal value of 1, removing that highest view count gain rate from the list and repeating the process using the next highest view count gain rates and the next higher ordinal value. The process could be repeated until the entire list of view count gain rates has been exhausted. If users selected the same content item for the contest the users would share that rank. Further, if a user selected more than one content item to compete in the contest, the user would be assigned more than one rank. In some embodiments where users are allowed to select more than one content item to compete in the contest, all of the view count gain rates of the content items selected by that user could be averaged out to obtain a single view count gain rate. Still further, other calculations may be made using the view count gain rate for content items selected by a user in order to determine the rank for a particular user as is described further with reference to other Figures.

In the example of FIG. 3, the user rank (320) for each user is stored in a user rank table (140D), which is one of the tables (140) described with reference to FIG. 2. The user rank table (140D) of FIG. 3 has two fields: user ID (102) and user rank (320). User ID (102) of FIG. 3 stores a unique identifier for one of the users participating in the contest to forecast popular content items. User Rank (320) stores a value reflecting the performance of a particular user relative to other users participating in the contest.

In the example of FIG. 3, the data processing system publishes (310) the user rank (320A) for at least one of the users. In this particular example, the user rank ‘1’ is published for user ‘CWei’. Publishing (310) the user rank (320A) for one of the users in the example of FIG. 3 may be carried out by providing the user rank (320A) to a web server for incorporation into a web page published on the world wide web by the web server. In alternative embodiments, publishing (310) the user rank (320A) for at least one of the users in the example of FIG. 3 may be carried out by emailing all of the users all of the user rankings from the contest. In still further embodiments, publishing (310) the user rank (320A) for at least one of the users in the example of FIG. 3 may be carried out by encapsulating the user rankings from the contest in a JSON object and transmitting that JSON object to a requestor in response to a request received through a web services API.

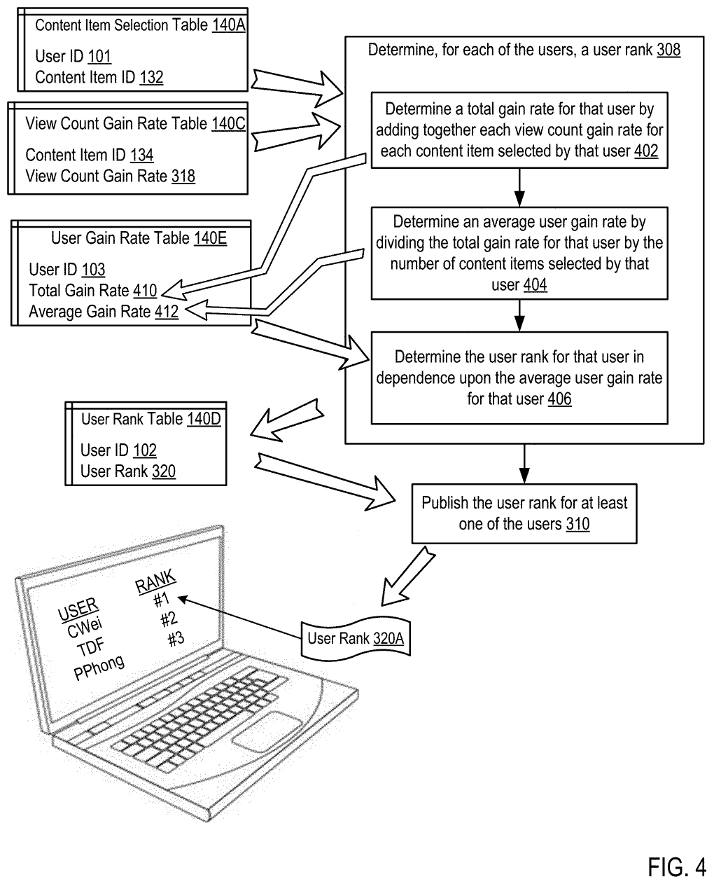

As mentioned above, the data processing system may determine user rank by various calculations using the view count gain rate for content items selected by a user. For further explanation, FIG. 4 sets forth a flow chart illustrating another exemplary method for determining a user rank for each of the users according to embodiments of the present invention. The example of FIG. 4 includes a content item selection table (140A), view count gain rate table (140C), and a user rank table (140D), all having similar structures and operating in a manner similar as described with reference to FIG. 3.

In the example of FIG. 4, determining (308) a user rank (320) for each of the users includes determining (402) a total gain rate (410) for that user by adding together each view count gain rate (318) for each content item (130) selected by that user. The total gain rate (410) of FIG. 4 represents the aggregate value of all of the view count gain rates for all of the content items selected by a particular user in a contest. Determining (402) a total gain rate (410) for that user in the example of FIG. 4 may be carried out by joining the content item selection table (140A) with the view count gain rate table (140C) on the content item ID (132, 134) fields. Joining the content item selection table (140A) and the view count gain rate table (140C) would result in a table where the view count gain rate (318) field and the user ID (101) field were both associated, and a data processing system could then lookup the view count gain rate (318) based on a particular user ID (101). For example, consider the following exemplary content item selection table (140A) and the view count gain rate table (140C):

TABLE 3
Example Content Item Selection Table

| User ID | Content Item ID |
|---|---|
| PPhong | video102 |
| CWei | video101 |
| TDF | video104 |
| PPhong | video104 |
| CWei | video105 |

TABLE 4
Example View Count Gain Rate Table

| Content Item ID | View Count Gain Rate |
|---|---|
| video100 | 1,534 |
| video101 | 4,178 |
| video102 | 597 |
| video103 | 2,111 |
| video104 | 1,479 |
| video105 | 3,842 |

Joining Table 3 and Table 4 in this example would result in the following exemplary joined table:

TABLE 5
Example of Joined Tables 3 and 4

| | | View Count Gain Rate |
|---|---|---|
| User ID | Content Item ID | (in views per day) |
| PPhong | video102 | 597 |
| CWei | video101 | 4,178 |
| TDF | video104 | 1,479 |
| PPhong | video104 | 1,479 |
| CWei | video105 | 3,842 |

The join of tables described here with reference to FIG. 4 may be carried out using Structured Query Language (SQL) commands. SQL is a platform-specific language used in programming and designed for managing data held in a relational database management system (RDBMS), or for stream processing in a relational data stream management system (RDSMS). The variation of SQL employed in any particular RDMBS or RDSMS is typically selected by the database designer.

Determining (402) a total gain rate (410) for that user in the example of FIG. 4 may be carried out by retrieving from the joined table all of values for the view count gain rate (318) for that user and adding the values together as the total gain rate (410) for that user. Continuing with the exemplary Table 5, the total gain rate for user ‘CWei’ would be 8,020 (4,178 plus 3,842). The total gain rate (410) in the example of FIG. 4 is stored in the user gain rate table (140E), which is one of the tables (140) described with reference to FIG. 2. The user gain rate table (140E) has three fields: user ID (103), total gain rate (410), and average gain rate (412). The user ID (103) stores a unique identifier for one of the users participating in the contest to forecast popular content items. Total gain rate (410) stores the total gain rate calculated for the user identified by the associated user ID. Average gain rate (412) stores the average gain rate calculated for the user identified by the associated user ID.

In the example of FIG. 4, determining (308) a user rank (320) for each of the users also includes determining (404) an average user gain rate (412) by dividing the total gain rate (410) for that user by the number of content items (130) selected by that user. Dividing the total gain rate (410) for that user in the example of FIG. 4 may be carried out by determining the number of entries for a user in the joined tables (140A, 140C) and dividing the total gain rate (410) by the number of entries for a user in the joined tables (140A, 140C). Continuing with the exemplary Table 5, the numbered of entries for user ‘CWei’ would be 2, and the average gain rate for user ‘CWei’ would be 4,010 (8,020 divided by 2).

In this way, determining (404) an average user gain rate (412) for a particular user in the example of FIG. 4 may be carried out according to the following formula:

$$\frac{{\sum }_{k = 1}^{m} view count gain rate for content item k of a user}{m}$$

where m is the total number of content items selected by the user for a particular contest.

In the example of FIG. 4, determining (308) a user rank (320) for each of the users also includes determining (406) the user rank (320) for each user in dependence upon the average user gain rate (412) for that user. Determining (406) the user rank (320) for each user in dependence upon the average user gain rate (412) for that user in the example of FIG. 4 may be carried out by simply assigning the average user gain rate (412) for that user as the user rank (320) for that user. Of course, in other embodiments, determining (406) the user rank (320) for each user in dependence upon the average user gain rate (412) for that user in the example of FIG. 4 may be carried out by scanning all of the average user gain rates for the highest value, assigning the user associated with the highest average user gain rate the ordinal value of 1, removing that highest average user gain rate from the list and repeating the process using the next highest average user gain rate and the next higher ordinal value. The process could be repeated until the entire list of average user gain rates has been exhausted.

The example of FIG. 4 also includes publishing (310) the user rank (320A) for at least one of the users, which may be carried out in the manner described with reference to FIG. 3.

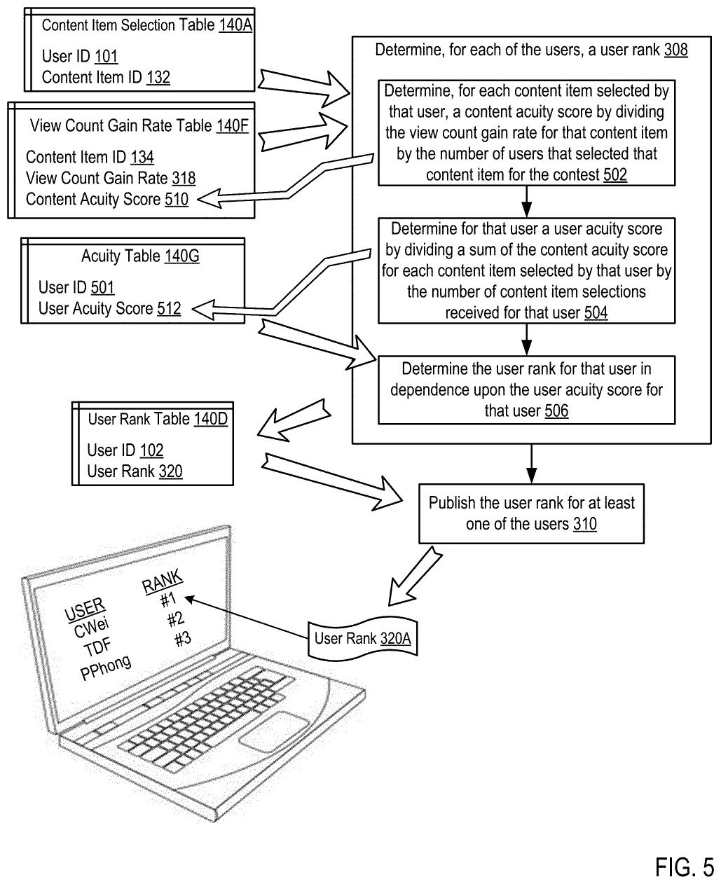

As mentioned, there are a variety of other methods for determining a user rank for each of the users in dependence upon a view count gain rate according to embodiments of the present invention. For further explanation, FIG. 5 sets forth a flow chart illustrating another exemplary method for determining a user rank for each of the users according to embodiments of the present invention. The example of FIG. 5 includes a content item selection table (140A) and a user rank table (140D), all having similar structures and operating in a manner similar as described with reference to FIG. 3.

In the example of FIG. 5, determining (308), for each of the users, a user rank (320) includes determining (502), for each content item (130) selected by that user, a content acuity score (510) by dividing the view count gain rate (318) for that content item by the number of users that selected that content item for the contest. The content acuity score (510) of FIG. 5 represents a measure of the consensus among contest users regarding the future popularity of a particular content item. Assuming a set of content items all have the same view count gain rates, the higher the content acuity score (510) of FIG. 5 is for a content item, the fewer number of users actually thought that content item would be popular. By contrast, the lower the content acuity score (510) of FIG. 5 is for a content item, the higher number of users actually thought that content item would be popular.

The view count gain rate (318) of FIG. 5 for each content item selected for the contest is stored in the view count gain rate table (140F), which is one of the tables (140) described with reference to FIG. 2. The view count gain rate table (140F) of FIG. 5 is similar to the view count gain rate table (140C) of FIG. 3, having the same fields plus one additional field. The fields in the view count gain rate table (140F) of FIG. 5 are as follows: content item ID (134), view count gain rate (318), and content acuity score (510). As mentioned, content item ID (134) stores a unique identifier for a particular content item, and the view count gain rate (318) stores the view count gain rate determined for a particular content item over the time period (312). The content acuity score (510) field of FIG. 5 stores the value representing the consensus among contest users regarding the future popularity of an associated content item.

In the example of FIG. 5, determining (502) a content acuity score (510) for each content item (130) by dividing the view count gain rate (318) for that content item by the number of users that selected that content item for the contest may be carried out by joining the content item selection table (140A) with the view count gain rate table (140F) on the content item ID (132, 134) fields. Similar to the manner described with reference to FIG. 4, joining the content item selection table (140A) and the view count gain rate table (140F) would result in a table where the view count gain rate (318) field and the user ID (101) field were both associated, and a data processing system could then lookup the view count gain rate (318) based on a particular user ID (101) and vice versa. For example, consider again the exemplary content item selection table (140A) in Table 3 and the following exemplary view count gain rate table (140F):

TABLE 6
Example View Count Gain Rate Table

| Content Item ID | View Count Gain Rate | Content Acuity Score |
|---|---|---|
| video100 | 1,534 | |
| video101 | 4,178 | |
| video102 | 597 | |
| video103 | 2,111 | |
| video104 | 1,479 | |
| video105 | 3,842 | |

Joining Table 3 and Table 6 in this example would result in the following exemplary joined table:

TABLE 7
Example of Joined Tables 3 and 6

| | | | Content Acuity Score |
|---|---|---|---|
| | Content | View Count Gain Rate | (in views per day |
| User ID | Item ID | (in views per day) | per user selection) |
| PPhong | video102 | 597 | |
| CWei | video101 | 4,178 | |
| TDF | video104 | 1,479 | |
| PPhong | video104 | 1,479 | |
| CWei | video105 | 3,842 | |

By joining the exemplary content item selection table (140A) of Table 3 and the exemplary view count gain rate table (140F) of Table 6, the joined Table 7 lists only content items selected by users for the contest. Any of other content items not selected by users for this particular contest get filtered out in the joining of the tables.

In the example of FIG. 5, determining (502) a content acuity score (510) for each content item (130) may further be carried out by identifying how many times a particular content item ID appears in the joined table. The number of times a particular content item ID appears in the joined table represents the number of users that selected that associated content item. Determining (502) a content acuity score (510) for each content item (130) according to the example of FIG. 5 may then be carried out by dividing the view count gain rate (318) associated with each content item ID (134) in the joined table by the number of times a particular content item ID appears in the joined table and writing the value in the content acuity score (512) field of the joined table and the view count gain rate table (140F). For further example, consider Table 8 which is similar to Table 7 except that the content acuity scores are inserted into the table:

TABLE 8
Example of Joined Tables 3 and 6 with
Content Acuity Score Inserted

| | | | Content Acuity Score |
|---|---|---|---|
| | Content | View Count Gain Rate | (in views per day per |
| User ID | Item ID | (in views per day) | user selection) |
| PPhong | video102 | 597 | 597 |
| CWei | video101 | 4,178 | 4,178 |
| TDF | video104 | 1,479 | 739.5 |
| PPhong | video104 | 1,479 | 739.5 |
| CWei | video105 | 3,842 | 3,842 |

In the example of Table 8, the content acuity scores for content items ‘video101’, ‘video102’, and ‘video105’ are the same as the view count gain rates for those content items. The content acuity score for content item ‘video104’, however, is one-half of view count gain rates for that content item because two people selected ‘video104’.

In the example of FIG. 5, determining (308), for each of the users, a user rank (320) includes determining (504) for that user a user acuity score (512) by dividing a sum of the content acuity score (510) for each content item selected by that user by the number of content item selections received for that user. The user acuity score (512) of FIG. 5 represents a measure of whether a user is pioneer by selecting content items not selected by many other users or whether a user is a follower by selecting content items that many other users select. The higher the user acuity score (512) of FIG. 5 is for a user, the more that user is a pioneer with their predictive acumen for content popularity. In contrast, the lower the user acuity score (512) of FIG. 5 is for a user, the more that user is a follower with other users regarding their predictive acumen for content popularity.

In the example of FIG. 5, determining (504) for that user a user acuity score (512) in the example of FIG. 5 may be carried out by scanning the table created from the join of the content item selection table (140A) and the view count gain rate table (140F), retrieving the content acuity score (510) for each content item selected by that user, dividing the sum of the retrieved content acuity scores by the number of entries in the joined table for that particular user. The user acuity score (512) of FIG. 5 is stored in the acuity table (140G), which is one of the tables (140) described with reference to FIG. 2. The acuity table (140G) of FIG. 5 has two fields: one field for the user ID (501) and another field for the user acuity score (512).

When expressed mathematically, determining (504) a user acuity score (512) for a user in the example of FIG. 5 may be carried out according to the following formula:

$$\frac{{\sum }_{k = 1}^{m} ( VCGR for content item k of a user \div \\ Number of users selecting content item k )}{( m )}$$

where VCGR is the view count gain rate of a particular content item, and
where m is the total number of content items selected by the user for a particular contest.

In the example of FIG. 5, determining (308), for each of the users, a user rank (320) includes determining (506) the user rank (320) for that user in dependence upon the user acuity score (512) for that user. Determining (506) the user rank (320) for that user in dependence upon the user acuity score (512) for that user according the example of FIG. 5 may be carried out by simply assigning the user acuity score (512) for that user as the user rank (320) for that user. Of course, in other embodiments, determining (506) the user rank (320) for that user in dependence upon the user acuity score (512) for that user in the example of FIG. 5 may be carried out by scanning all of the user acuity scores for the highest value, assigning the user associated with the highest user acuity score the ordinal value of 1, removing that highest user acuity score from the list and repeating the process using the next highest user acuity score and the next higher ordinal value. The process could be repeated until the entire list of user acuity scores has been exhausted.

The example of FIG. 5 also includes publishing (310) the user rank (320A) for at least one of the users, which may be carried out in the manner described with reference to FIG. 3.

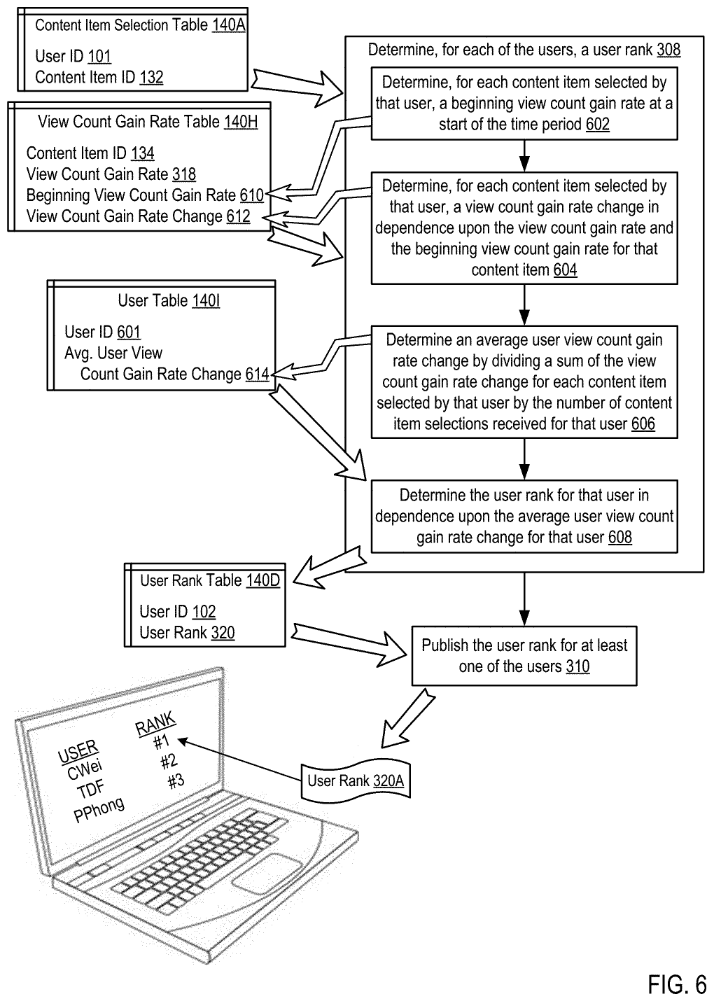

As mentioned, there are a variety of methods for determining a user rank for each of the users in dependence upon a view count gain rate according to embodiments of the present invention. For further explanation of another method of determining a user rank, FIG. 6 sets forth a flow chart illustrating another exemplary method for determining a user rank for each of the users according to embodiments of the present invention. The example of FIG. 6 includes a content item selection table (140A) and a user rank table (140D), all having similar structures and operating in a manner similar as described with reference to FIG. 3.

In the example of FIG. 6, determining (308), for each of the users, a user rank (320) includes determining (602), for each content item selected by that user, a beginning view count gain rate (610) at a start of the time period. The beginning view count gain rate (610) of FIG. 6 for a content item represents the average number of times that the content item was consumed during the pre-contest time period starting when the user selects the content item for participation in the contest and ending at the beginning of the contest. Like view count gain rate (318), beginning view count gain rate (610) of FIG. 6 is express in terms of consumption over each of the times units used to express the pre-contest time period. For example, if a content item has 7,000 views when a user selects the content item for inclusion in the contest and the content item has 10,000 views two (2) days later when the contest time period begins, the exemplary beginning view count gain rate would be calculated as follows:

$$\frac{( \text{10,000} views - \text{7,000} views )}{2 days} = \text{1,500} \frac{views}{day}$$

In the example of FIG. 6, determining (602), for each content item selected by that user, a beginning view count gain rate (610) at a start of the time period may be carried out by requesting from the content provider the view count for a content item when the content item selection for that content item is received from a user, requesting the view count again for the same content item at the beginning of the time period from the content provider, and calculating the difference between the view counts when the content item selection was first received and at the beginning of the time period—this being done for each of the content items identified in the content item selection table (140A).

The beginning view count gain rate (610) of FIG. 6 for each content item selected for the contest is stored in the view count gain rate table (140H), which is one of the tables (140) described with reference to FIG. 2. The view count gain rate table (140H) of FIG. 6 is similar to the view count gain rate table (140C) of FIG. 3, having the same fields plus two additional fields. The fields in the view count gain rate table (140H) of FIG. 6 are as follows: content item ID (134), view count gain rate (318), beginning view count gain rate (610), and view count gain rate change (612). The beginning view count gain rate (610) field of FIG. 6 stores the value representing the average number of times that the content item was consumed during the pre-contest time period starting when the user selects the content item for participation in the contest and ending at the beginning of the contest. The view count gain rate change (612) field of FIG. 6 stores a value representing the change in the average number of times that the content item was consumed during the pre-contest time period when compared to the actual contest time period.

In the example of FIG. 6, determining (308), for each of the users, a user rank (320) includes determining (604), for each content item selected by that user, a view count gain rate change (612) in dependence upon the view count gain rate (318) and the beginning view count gain rate (610) for that content item. The view count gain rate change (612) of FIG. 6 represents the change in the average number of times that the content item was consumed during the pre-contest time period starting when the user selects the content item for the contest as compared to the average number of times that the content item was consumed over the actual contest time period. In the example of FIG. 6, determining (604) a view count gain rate change (612) for each content item selected by a user may be carried out by calculating the difference between the beginning view count gain rate (610) and the view count gain rate (318) for each content item represented in the view count gain rate table (140H) and then storing the view count gain rate change (612) in back in the view count gain rate table (140H). For an example consider the following exemplary view county gain rate table (140H) shown here as Table 9:

TABLE 9
Example View Count Gain Rate Table

| | View Count Gain | Beginning View | View Count Gain |
|---|---|---|---|
| Content | Rate | Count Gain Rate | Rate Change |
| Item ID | (in views per day) | (in views per day) | (in views per day) |
| video100 | 1,534 | 1,005 | 529 |
| video101 | 4,178 | 213 | 3,965 |
| video102 | 597 | 27 | 570 |
| video103 | 2,111 | 1,039 | 1,072 |
| video104 | 1,479 | 1,211 | 268 |
| video105 | 3,842 | 1,542 | 2,300 |

In the exemplary Table 9, the view count gain rate change (612) for the content item identified as ‘video100’ is 529 views per day, which is the difference between the view count gain rate (318) of 1,534 views per day during the contest time period and the beginning view count gain rate (610) of 1,005 views per day during the pre-contest time period.

In the example of FIG. 6, determining (308), for each of the users, a user rank (320) also includes determining (606) an average user view count gain rate change (614) by dividing a sum of the view count gain rate change (612) for each content item selected by that user by the number of content item selections received for that user. Determining (606) an average user view count gain rate change (614) according to the example of FIG. 6 may be carried out by joining the content item selection table (140A) and the view count gain rate table (140H) on the content item ID (132, 134) fields. Similar to the manner described with reference to FIGS. 4 and 5, joining the content item selection table (140A) and the view count gain rate table (140H) in such a manner would result in a table where the view count gain rate change (612) field, content item ID (132) field, and the user ID (101) field were all associated, and a data processing system could then lookup information from that joined table using any of those fields. For example, consider the following exemplary table that reflects the join of the exemplary content item selection table (140A) shown as Table 3 and the following exemplary view count gain rate table (140H) shown as Table 9:

TABLE 10
Example Joined Table of Table 3 and Table 9

| | | | Beginning | View Count |
|---|---|---|---|---|
| | | View Count | View Count | Gain Rate |
| | | Gain Rate | Gain Rate | Change |
| User | Content | (in views | (in views | (in views |
| ID | Item ID | per day) | per day) | per day) |
| PPhong | video102 | 597 | 27 | 570 |
| CWei | video101 | 4,178 | 213 | 3,965 |
| TDF | video104 | 1,479 | 1,211 | 268 |
| PPhong | video104 | 1,479 | 1,211 | 268 |
| CWei | video105 | 3,842 | 1,542 | 2,300 |

In the example of FIG. 6, determining (606) an average user view count gain rate change (614) may further be carried out by identifying all of the rows in the joined table for a particular user, adding up all of the view count gain rate change (612) values in the identified rows, and dividing the sum by the number of rows identified. Continuing with the example shown in Table 10, the average user view count gain rate change (614) for the user identified as ‘CWei’ would be 3,132.5 views per day, which is the view count gain rate change for ‘video101’ and ‘video105’ added together and divided by 2, or rather (3,965+2,300)÷2.

Determining (606) an average user view count gain rate change (614) according to the example of FIG. 6 may further be carried out by storing the average user view count gain rate for each user in the user table (140I). The user table (140I) of FIG. 6 is one of the tables (140) described with reference to FIG. 2. In the example of FIG. 6, the user table (140I) has two fields: user ID (601) and average user view count gain rate (614). Each row of the user table (140I) associates an average user view count gain rate (614) with a particular user identified by the user ID (601). For further example, consider again the exemplary data from Table 10. Using the data from Table 10, a data processing system may determine (606) an average user view count gain rate change (614) for each user in exemplary Table 10 to produce the following exemplary user table (140I):

TABLE 11
Example User Table

| | Average User View Count Gain Rate Change |
|---|---|
| User ID | (in views per day) |
| PPhong | 419 |
| CWei | 3,132.5 |
| TDF | 268 |

When expressed mathematically, determining (606) an average user view count gain rate change (614) for a user according to the example of FIG. 6 may be carried out according to the following formula:

$$\frac{{\sum }_{k = 1}^{m} ( VCGR for content item k of a user \div \\ BVCGR for content item k of that user )}{( m )}$$

where VCGR is the view count gain rate of a particular content item,
where BVCGR is the beginning view count gain rate of a particular content item, and
where m is the total number of content items selected by the user for a particular contest.

In the example of FIG. 6, determining (308), for each of the users, a user rank (320) also includes determining (608) the user rank (320) for that user in dependence upon the average user view count gain rate change (614) for that user. Determining (608) the user rank (320) for that user in dependence upon the average user view count gain rate change (614) for that user according to the example of FIG. 6 may be carried out by simply assigning the average user view count gain rate change (614) for that user as the user rank (320) for that user. Of course, in other embodiments, determining (608) the user rank (320) for that user in dependence upon the average user view count gain rate change (614) for that user in the example of FIG. 6 may be carried out by scanning all of the average user view count gain rate changes for the highest value, assigning the user associated with the highest average user view count gain rate change the ordinal value of 1, removing that highest average user view count gain rate change from the list and repeating the process using the next highest average user view count gain rate change and the next higher ordinal value. The process could be repeated until the entire list of average user view count gain rate changes has been exhausted.

The example of FIG. 6 also includes publishing (310) the user rank (320A) for at least one of the users, which may be carried out in the manner described with reference to FIG. 3.

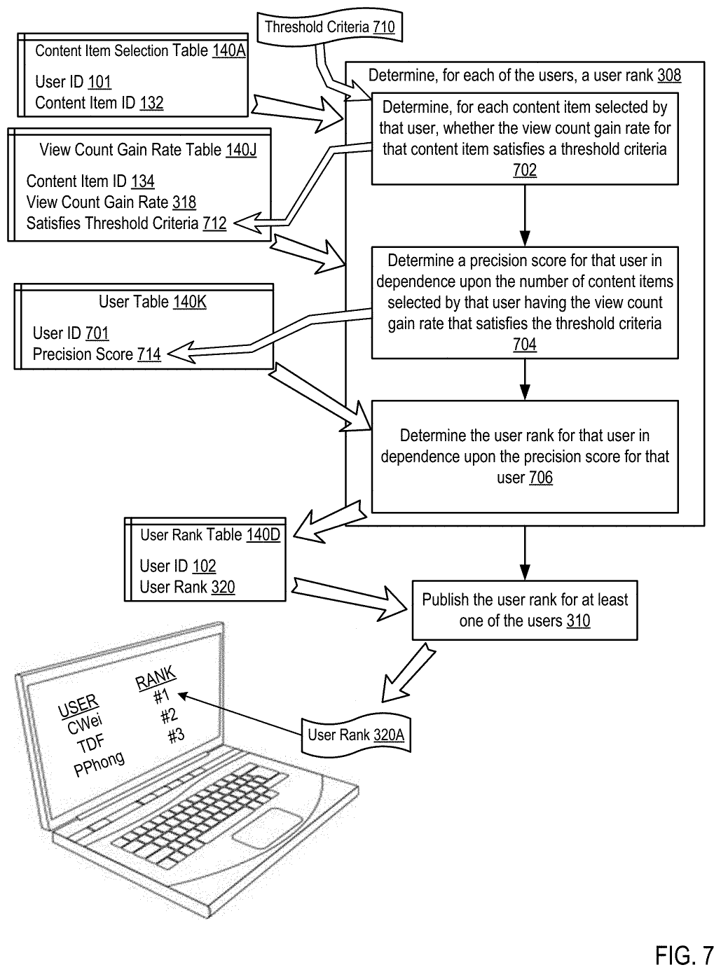

For further explanation of another method of determining a user rank, FIG. 7 sets forth a flow chart illustrating another exemplary method for determining a user rank for each of the users according to embodiments of the present invention. The example of FIG. 7 includes a content item selection table (140A) and a user rank table (140D), all having similar structures and operating in a manner similar as described with reference to FIG. 3.

In the example of FIG. 7, determining (308), for each of the users, a user rank (320) includes determining (702), for each content item selected by that user, whether the view count gain rate (318) for that content item satisfies a threshold criteria (710). The threshold criteria (710) of FIG. 7 is a metric applied to the view count gain rate (318) for each content item selected for participation in the contest. When applied, threshold criteria (710) of FIG. 7 is a useful way to identify whether such content items have desirable qualities. Applying such threshold criteria (710) to the content items allows the data processing system to measure how well each user in the contest performs at selecting content items that embody the criteria. The threshold criteria (710) of FIG. 7 are typically determined by the contest administrator or sponsor. Examples of threshold criteria (710) useful in the example of FIG. 7 include content items having a certain minimum view count gain rate, minimum view count gain rate change, minimum content acuity score, as well as many other criteria as will occur to those of skill in the art.

The example of FIG. 7 includes a view count gain rate table (140J), which is one of the tables (140) described with reference to FIG. 2. The view count gain rate table (140J) of FIG. 7 is similar to the view count gain rate table (140C) described with reference to FIG. 3 but with an additional field that stores a value indicating whether the particular content item referenced satisfies the threshold criteria (710). The view count gain rate table (140J) of FIG. 7 includes three fields: content item ID (134), view count gain rate (318), and satisfied threshold criteria (712). The fields for content item ID (134) and view count gain rate (318) are the same as in the view count gain rate table (140C) of FIG. 3. Satisfied threshold criteria (712) field stores a value representing whether a particular content item satisfied the defined threshold criteria (710). In the example of FIG. 7, a value of ‘TRUE’ represents that the particular content item satisfies the defined threshold criteria (710), and a value of ‘FALSE’ represents that the particular content item does not satisfy the defined threshold criteria (710).

The manner in which a data processing system determines (702) whether the view count gain rate (318) for that content item satisfies a threshold criteria (710) according to the example of FIG. 7 depends on the way in which the threshold criteria (710) is defined. Generally, however, determining (702) whether the view count gain rate (318) for that content item satisfies a threshold criteria (710) in the example of FIG. 7 may be carried out by retrieving the view count gain rate (318) from the view count gain rate table (140J) for each content item represented in the table (140J), applying the view count gain rate (318) to the formula defined by the threshold criteria (710), comparing the result from applying the view count gain rate (318) to the formula with the threshold criteria (710), and storing a value representing ‘TRUE’ or ‘FALSE’ in the satisfies threshold criteria (712) field depending on the comparison of the result with the threshold criteria (710). Consider again for example the view count gain rate table described as Table 4, and consider a threshold criteria being that the view count gain rate for a content item should be equal to or greater than 3,000 views per day. Determining (702) whether the view count gain rate (318) for that content item satisfies a threshold criteria (710) in the example of FIG. 7 results in the following Table 12:

TABLE 12
Example View Count Gain Rate Table

| | View Count Gain Rate | Satisfies Threshold |
|---|---|---|
| Content Item ID | (views per day) | Criteria |
| video100 | 1,534 | FALSE |
| video101 | 4,178 | TRUE |
| video102 | 597 | FALSE |
| video103 | 2,111 | FALSE |
| video104 | 1,479 | FALSE |
| video105 | 3,842 | TRUE |

In the example of FIG. 7, determining (308), for each of the users, a user rank (320) includes determining (704) a precision score (714) for that user in dependence upon the number of content items selected by that user having the view count gain rate (318) that satisfies the threshold criteria (710). The precision score (714) of FIG. 7 is a measure of how well each user in the contest performs at selecting content items that have desirable qualities embodied in the threshold criteria (710). The precision score (714) of FIG. 7 is stored in user table (140K), which is one of the tables (140) described with reference to FIG. 2. The user table (140K) of FIG. 7 has two fields: user ID (701) and precision score (714).

Determining (704) a precision score (714) for that user in accordance with the example of FIG. 7 may be carried out by joining the content item selection table (140A) and the view count gain rate table (140J) on the content item ID (132, 134) fields. Using the example of Table 3 and Table 12, the resulting joined table is shown here in Table 13:

TABLE 13
Example of Joined Tables 3 and 12

| | Content | View Count Gain Rate | Satisfies Threshold |
|---|---|---|---|
| User ID | Item ID | (in views per day) | Criteria |
| PPhong | video102 | 597 | FALSE |
| CWei | video101 | 4,178 | TRUE |
| TDF | video104 | 1,479 | FALSE |
| PPhong | video104 | 1,479 | FALSE |
| CWei | video105 | 3,842 | TRUE |

After joining these tables (140A, 140J), determining (704) a precision score (714) for that user in accordance with the example of FIG. 7 may be carried out by identifying in the joined tables (140A, 140J) the number of content items selected by that user that have satisfies threshold criteria (712) values of ‘FALSE’ and ‘TRUE’, dividing the number of content items having satisfies threshold criteria (712) values of ‘TRUE’ by the total number of content items selected by that user, and storing the result of the division as the precision score (714) for that user in the user table (140K). Continuing with the example of Table 13, determining precision scores for the users in the example of FIG. 7 would result in the following exemplary Table 14:

TABLE 14
Example of User Table

| | Precision Score |
|---|---|
| User ID | (as a percentage) |
| PPhong | 0% |
| CWei | 100% |
| TDF | 0% |

When expressed mathematically, determining (704) a precision score (714) for that user in accordance with the example of FIG. 7 may be carried out according to the following formula:

$$\frac{{\sum }_{k = 1}^{m} {N}_{Criteria Satisfied}}{m}$$

where N_{Criteria Satisfied} is the total number of content items selected by a user for a particular contest that satisfied the threshold criteria, and
where m is the total number of content items selected by the user for a particular contest.

In the example of FIG. 7, determining (308), for each of the users, a user rank (320) includes determining (706) the user rank (320) for that user in dependence upon the precision score (714) for that user. Determining (706) the user rank (320) for that user in dependence upon the precision score (714) for that user according to the example of FIG. 7 may be carried out by simply assigning the precision score (714) for that user as the user rank (320) for that user. Of course, in other embodiments, determining (706) the user rank (320) for that user in dependence upon the precision score (714) for that user in the example of FIG. 7 may be carried out by scanning all of the precision scores for the highest value, assigning the user associated with the highest precision score the ordinal value of 1, removing that highest precision score from the list and repeating the process using the next highest precision score and the next higher ordinal value. The process could be repeated until the entire list of precision scores has been exhausted.

The example of FIG. 7 also includes publishing (310) the user rank (320A) for at least one of the users, which may be carried out in the manner described with reference to FIG. 3.

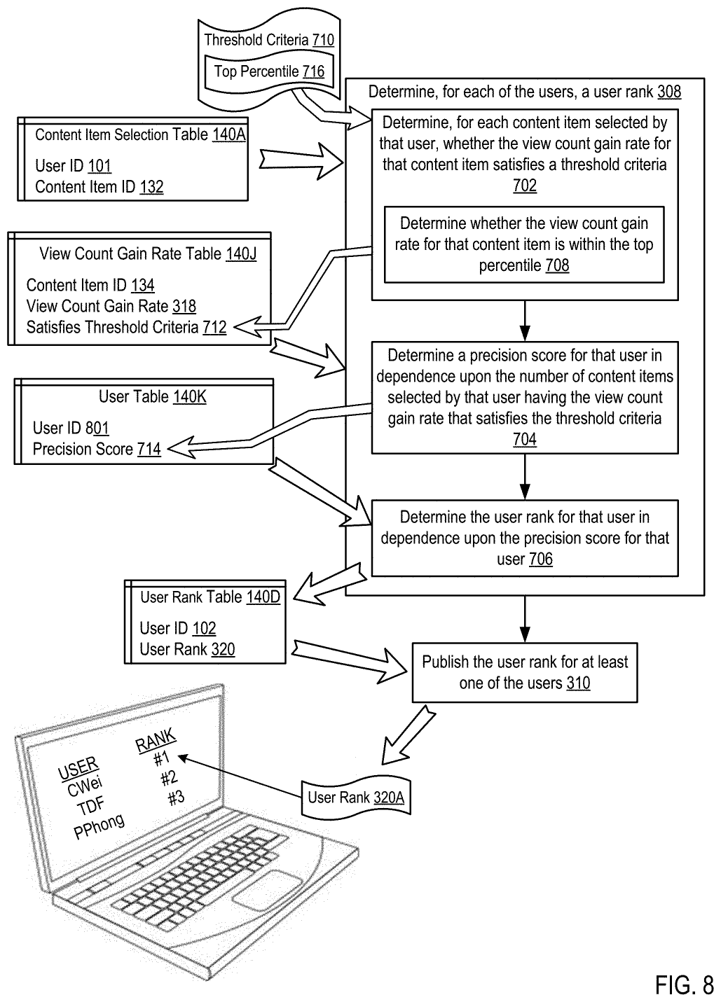

As mentioned, the threshold criteria useful in embodiments of the present invention may be implement in a variety of ways. In some embodiments, the threshold criteria may depend on the dataset applied to the criteria—in this way, the threshold criteria in absolute terms is dynamically adapted for each contest. For example, the threshold criteria may consist of a content item having a view count gain rate that is in a top percentile of all view count gain rates for content items selected for a contest. For further explanation, FIG. 8 sets forth a flow chart illustrating another exemplary method for determining a user rank for each of the users according to embodiments of the present invention. The example of FIG. 8 is similar to the example of FIG. 7 except that the threshold criteria (710) of FIG. 8 requires that a content item have a view count gain rate that is in a top percentile (716) of all view count gain rates for content items selected for a contest.

As such, determining (702) whether the view count gain rate (318) for that content item satisfies a threshold criteria in the example of FIG. 8 includes determining (708) whether the view count gain rate (318) for that content item is within the top percentile (716). The top percentile (716) of FIG. 8 is a score for which a given percentage of scores in a frequency distribution are at or above. For example, the top 50th percentile (the median) is the score for which 50% of the scores are at or above. For further example, the top 10th percentile is the score for which 10% of the scores are at or above.

Determining (708) whether the view count gain rate (318) for that content item is within the top percentile (716) in the example of FIG. 8 includes ordering the view count gain rates for all of the content items selected by users for the contest, determining the percentile threshold value demarcating the top percentile (716), scanning the joined content item selection table (140A) and the view count gain rate table (140J) for view count gain rates (318) at or above the percentile threshold value, and storing a value represent ‘TRUE’ in the satisfied threshold criteria (712) when the view count gain rates (318) are above the percentile threshold value.

In the example of FIG. 8, the percentile threshold value demarcating the top percentile (716) in the ordered list of view count gain rates may be determined according to any number of methods for calculating rank based on a percentile including, for example, nearest-rank method, the linear interpolation between closest ranks method, the weighted percentile method, or any number of other methods as will occur to those of skill in the art. In this example, the nearest rank method is applied according to the following formula:

$$Percentile Rank = ⌊ \frac{100 - {P}_{top}}{100} \times N ⌋$$

where Pₜₒₚ is the top percentile, and
where N is the total number of content items selected by users for the contest.

The percentile rank calculated above indicates which item in the list of ordered view count gain rates is the percentile threshold value demarcating the top percentile (716) in the ordered list of view count gain rates. For an example, consider the following exemplary table of view count gain rates for all of the content items selected by users for the contest ordered from lowest to highest:

TABLE 15
Example of Ordered List of View Count Gain Rates

| | View Count Gain Rate |
|---|---|
| Content Item ID | (in views per day) |
| video102 | 597 |
| video108 | 1,103 |
| video104 | 1,479 |
| video105 | 3,842 |
| video106 | 3,847 |
| video113 | 4,095 |
| video101 | 4,178 |
| video171 | 4,392 |
| video115 | 5,151 |
| video120 | 7,743 |

Continuing with the example, consider that the top percentile (716) in this example is the top twenty-five (25) percentile. Applying the formula above, the percentile threshold value demarcating the top twenty-five (25) percentile in the exemplary ordered list of Table 15 may be calculated according to the following formula:

$$Percentile Rank = ⌊ \frac{100 - 25}{100} \times 10 ⌋ = 8$$

where Pₜₒₚ is the top percentile, and
where N is the total number of content items selected by users for the contest.

In Table 15, the 8th item in the ordered list is for the content item identified as ‘video171’ with a view count gain rate of 4,392 views per day. Now consider the following table 16:

TABLE 16
Example of Content Item Selection Table

| User ID | Content Item ID |
|---|---|
| PPhong | video102 |
| TDF | video108 |
| TDF | video104 |
| CWei | video105 |
| PPhong | video106 |
| PPhong | video113 |
| CWei | video101 |
| CWei | video171 |
| TDF | video115 |
| CWei | video120 |

Scanning a joined table composed of the content item selection table (140A) and the view count gain rate table (140J) for view count gain rates (318) at or above the percentile threshold value of 4,392, and storing a value represent ‘TRUE’ in the satisfied threshold criteria (712) when the view count gain rates (318) are above the percentile threshold value results in the following exemplary Table 17 when performing the join on Table 15 and Table 16:

TABLE 17
Example of Joined Table from Table 15 and Table 16
with additional satisfied threshold criteria field

| | Content | View Count Gain Rate | Satisfies Threshold |
|---|---|---|---|
| User ID | Item ID | (in views per day) | Criteria |
| PPhong | video102 | 597 | FALSE |
| TDF | video108 | 1,103 | FALSE |
| TDF | video104 | 1,479 | FALSE |
| CWei | video105 | 3,842 | FALSE |
| PPhong | video106 | 3,847 | FALSE |
| PPhong | video113 | 4,095 | FALSE |
| CWei | video101 | 4,178 | FALSE |
| CWei | video171 | 4,392 | TRUE |
| TDF | video115 | 5,151 | TRUE |
| CWei | video120 | 7,743 | TRUE |

The remaining steps of FIG. 8 are similar to the steps of FIG. 7 for determining (704) a precision score (714) for that user in dependence upon the number of content items selected by that user having the view count gain rate (318) that satisfies the threshold criteria (710), determining (706) the user rank (320) for that user in dependence upon the precision score (714) for that user, and publishing (310) the user rank (320A) for at least one of the users.

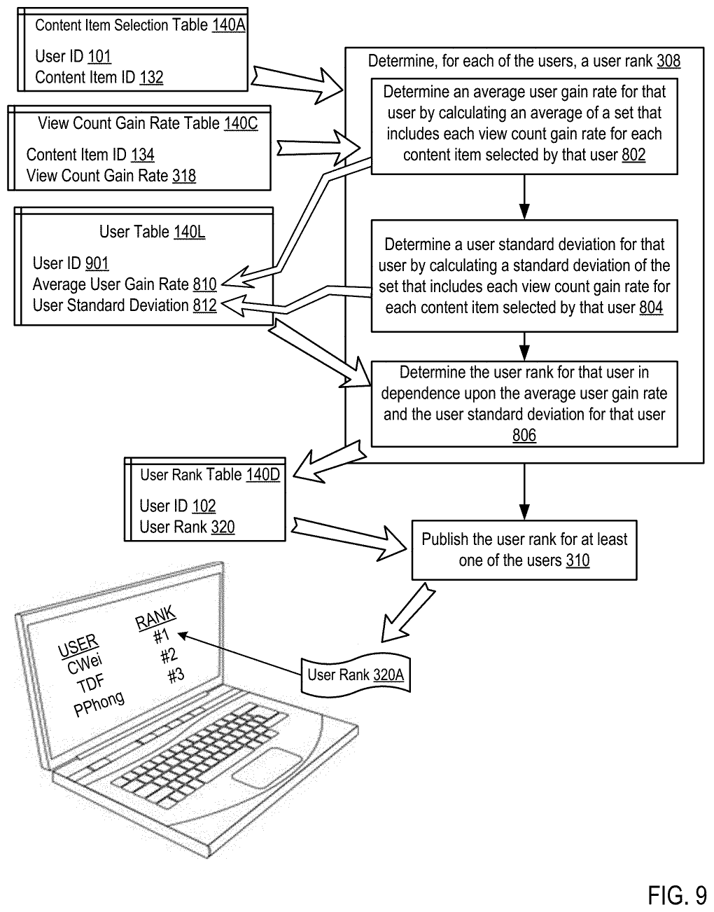

For further explanation of another method of determining a user rank, FIG. 9 sets forth a flow chart illustrating another exemplary method for determining a user rank for each of the users according to embodiments of the present invention. The example of FIG. 9 includes a content item selection table (140A), a view count gain rate table (140C), and user rank table (140D) all having similar structures and operating in a manner similar as described with reference to FIG. 3.

In the example of FIG. 9, determining (308), for each of the users, a user rank (320) includes determining (802) an average user gain rate (810) for that user by calculating an average of a set that includes each view count gain rate (318) for each content item selected by that user. In order to identify a set that includes each view count gain rate (318) for each content item selected by a user, a data processing system may join the content item selection table (140A) and the view count gain rate table (140C) on the content item ID (132, 134) fields. Consider the exemplary content item selection table of Table 16 and the exemplary view count gain rate table of Table 15, which when joined provides the exemplary Table 17 as follows:

TABLE 17
Example of Joined Table from Table 15 and Table 16

| | | View Count Gain Rate |
|---|---|---|
| User ID | Content Item ID | (in views per day) |
| PPhong | video102 | 597 |
| TDF | video108 | 1,103 |
| TDF | video104 | 1,479 |
| CWei | video105 | 3,842 |
| PPhong | video106 | 3,847 |
| PPhong | video113 | 4,095 |
| CWei | video101 | 4,178 |
| CWei | video171 | 4,392 |
| TDF | video115 | 5,151 |
| CWei | video120 | 7,743 |

In the example of FIG. 9, calculating an average of a set that includes each view count gain rate (318) for each content item selected by a particular user may be carried out by scanning the joined table based on the content item selection table (140A) and the view count gain rate table (140C), adding up all of the view count gain rates for that user, and dividing the added sum by the number of entries for that user in the joined table. The result is the average user gain rate for that particular user. The process may then be repeated for all of the users.

When expressed mathematically, calculating an average of a set that includes each view count gain rate (318) for each content item selected by a particular user may be carried out according to the following formula:

$$Average User Gain Rate = \frac{{\sum }_{k = 1}^{m} ( VCG {R}_{k} )}{m}$$

where VCGRₖ is the view count gain rate of a particular content item k selected by a user;
where m is the total number of content items selected by that user for a particular contest.

Using the exemplary Table 17 above, calculating an average of a set that includes each view count gain rate (318) for each content item selected by user ‘CWei’ would be carried out as follows:

$$\frac{\text{3,842} + \text{4,178} + \text{4,392} + \text{7,743}}{4} = \text{5,038.75} \text{views/day}$$

In the example of FIG. 9, determining (802) an average user gain rate (810) may then be carried out by storing the average user gain rate (810) in the user table (140L), which is one of the tables (140) described with reference to FIG. 2. The user table (140L) of FIG. 9 includes three fields: user ID (901), the average user gain rate (810), and the user standard deviation (812). Each row of the user table (140L) of FIG. 9 associates a user with the average user gain rate (810) calculated for that user and the user standard deviation (812) calculated for that user. For further example, determining (802) an average user gain rate (810) in the example of FIG. 9 using the information from Table 17, produces an exemplary user table such as the following Table 18:

TABLE 18
Example of User Table

| | Average User Gain Rate | User Standard Deviation |
|---|---|---|
| User ID | (in views per day) | (in views per day) |
| CWei | 5,038.75 | |
| PPhong | 2,846.33 | |
| TDF | 2,577.67 | |

Continuing with the example of FIG. 9, determining (308), for each of the users, a user rank (320) also includes determining (804) a user standard deviation (812) for that user by calculating a standard deviation of the set that includes each view count gain rate (318) for each content item selected by that user. Calculating a standard deviation of the set that includes each view count gain rate (318) for each content item selected by a user according to the example of FIG. 9 may be carried out according to the following formula:

$$User Standard Deviation = \sqrt{\frac{{\sum }_{k = 1}^{m} {( {VCGR}_{k} - {VCGR}_{avg} )}^{2}}{m - 1}}$$

where VCGRₖ is the view count gain rate of a particular content item k selected by a user;
where VCGR_{avg} is the average user gain rate calculated for that user;
where m is the total number of content items selected by that user for a particular contest.

Using the exemplary Table 17 above, determining (804) a user standard deviation (812) in the example of FIG. 9 for user ‘CWei’ would be carried out as follows:

$$\begin{matrix}User Standard Deviation = \sqrt{\frac{{( \text{3,842} - \text{5,038.75} )}^{2} + {( \text{4,178} - \text{5,038.75} )}^{2} + \\ {( \text{4,392} - \text{5,038.75} )}^{2} + {( \text{7,743} - \text{5,038.75} )}^{2}}{4 - 1}} \\ = \text{1,816.99} \text{views/day}\end{matrix}$$

This process is repeated for each of the users in the exemplary Table 17. Determining (804) a user standard deviation (812) in the example of FIG. 9 using the information from Table 17 and adding that information to Table 18, produces an exemplary user table such as the following Table 19:

TABLE 19
Example of User Table

| | Average User Gain Rate | User Standard Deviation |
|---|---|---|
| User ID | (in views per day) | (in views per day) |
| CWei | 5,038.75 | 1,816.99 |
| PPhong | 2,846.33 | 1,951.92 |
| TDF | 2,577.67 | 2,236.49 |

In the example of FIG. 9, determining (308), for each of the users, a user rank (320) includes determining (806) the user rank for that user in dependence upon the average user gain rate (810) and the user standard deviation (812) for that user. Determining (806) the user rank for that user in dependence upon the average user gain rate (810) and the user standard deviation (812) for that user according to the example of FIG. 9 may be carried out by simply assigning the user standard deviation (812) for that user as the user rank (320) for that user. Of course, in other embodiments, determining (806) the user rank for that user in dependence upon the average user gain rate (810) and the user standard deviation (812) for that user in the example of FIG. 9 may be carried out by scanning all of the user standard deviations for the lowest value, assigning the user associated with the lowest user standard deviation the ordinal value of 1, removing that lowest user standard deviation from the list and repeating the process using the next lowest user standard deviation and the next higher ordinal value. The process could be repeated until the entire list of user standard deviations has been exhausted.

The example of FIG. 9 also includes publishing (310) the user rank (320A) for at least one of the users, which may be carried out in the manner described with reference to FIG. 3.

In the example FIG. 9, a data processing system operating according to embodiments of the present invention determines user rank in dependence upon the user standard deviation. Ranking users in this way helps determine how users perform relative to each other regarding the range of their forecasts. Larger standard deviations for users indicate those users have a larger variation in the outcomes of their forecasts. Measuring the variations in the outcomes of users' forecasts may be advantageous in certain circumstances.

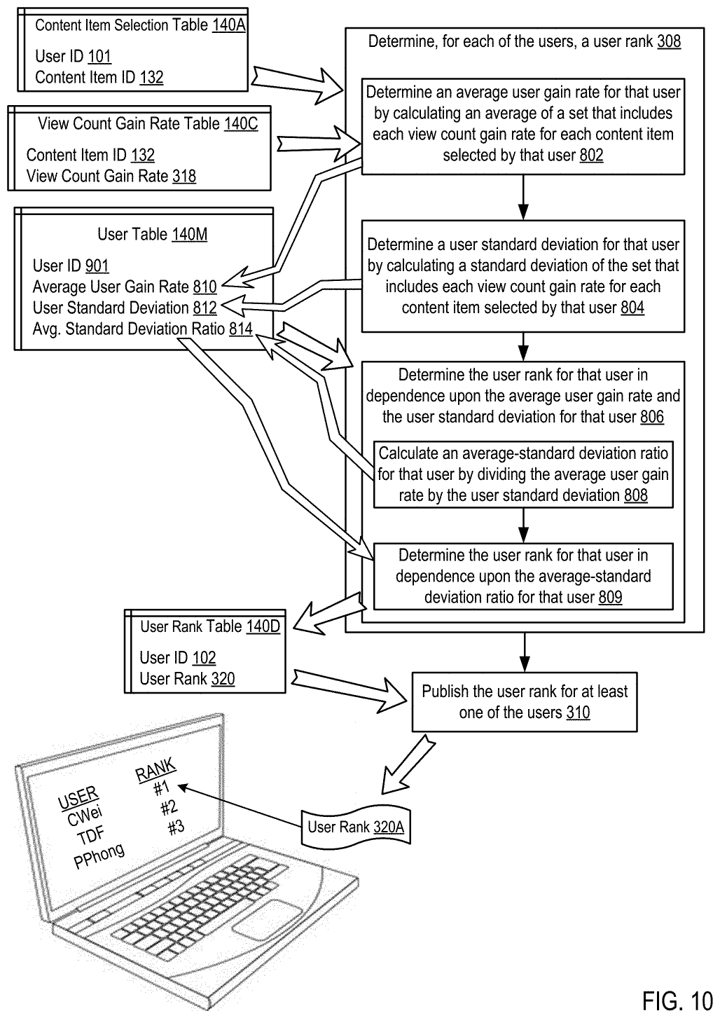

In some embodiments, measuring the variations in outcomes of users' forecasts with respect to those users' average view count gain rate might also be advantageous. Such measurement would provide insight into each user's consistency in forecasting popular content items. For further explanation, FIG. 10 sets forth a flow chart illustrating another exemplary method for determining (308) a user rank for each of the users according to embodiments of the present invention. The example of FIG. 10 is similar to the example of FIG. 9. That is, the example of FIG. 9 includes determining (802) an average user gain rate (810) for a user by calculating an average of a set that includes each view count gain rate (318) for each content item selected by that user; determining (804) a user standard deviation (812) for that user by calculating a standard deviation of the set that includes each view count gain rate (318) for each content item selected by that user; and determining (806) the user rank for that user in dependence upon the average user gain rate and the user standard deviation for that user. Also, the example of FIG. 10 includes a content selection table (140A), view count gain rate table (140C), and user rank table (140D) in a manner similar to the example of FIG. 9.

The example of FIG. 10 also includes a user table (140M), which is one of the tables (140) described with reference to FIG. 2. The user table (140M) of FIG. 10 is similar to the user table (140L) of FIG. 9 having all of the same fields and one additional field: the user ID (901), average user gain rate (810), user standard deviation (812), and average-standard deviation ratio (814). The average-standard deviation ratio (814) of FIG. 10 represents the average view count gain rate for a user adjusted for the user's consistency at selecting content items that produce similar view count gain rates. The average-standard deviation ratio (814) of FIG. 10 is calculated by dividing the average view count gain rate (810) for a user by the user standard deviation (812) for that user.

In the example of FIG. 10, therefore, determining (806) the user rank for that user is carried out by calculating (808) an average-standard deviation ratio (814) for that user by dividing the average user gain rate (810) by the user standard deviation (812). Calculating (808) an average-standard deviation ratio (814) for a user according to the example of FIG. 10 may be carried out by retrieving the average user gain rate (810) and the user standard deviation (812) from the user table (140M), dividing the average user gain rate (810) by the user standard deviation (812), and storing the result in the average-standard deviation ratio (814) in the user table (140M) for that user. Calculating (808) an average-standard deviation ratio (814) for a user according to the example of FIG. 10 may be carried out according to the following formula:

$$Average - Standard Deviation Ratio = \frac{Average User Gain Rate}{User Standard Deviation} = \frac{\frac{{\sum }_{k = 1}^{m} ( VCG {R}_{k} )}{m}}{\sqrt{\frac{{\sum }_{k = 1}^{m} {( VCG {R}_{k} - V C G {R}_{a v g} )}^{2}}{m - 1}}}$$

where VCGRₖ is the view count gain rate of a particular content item k selected by a user;
where VCGR_{avg} is the average user gain rate calculated for that user;
where m is the total number of content items selected by that user for a particular contest.

For an example, consider the exemplary values for average user gain rate and user standard deviation from Table 19 for the three users. Calculating (808) an average-standard deviation ratio (814) for each user would produce the following exemplary user table designed Table 20:

TABLE 20
Example of User Table

| | Average User | User Standard | |
|---|---|---|---|
| | Gain Rate | Deviation | Average-Standard |
| User ID | (in views per day) | (in views per day) | Deviation Ratio |
| CWei | 5,038.75 | 1,816.99 | 2.773 |
| PPhong | 2,846.33 | 1,951.92 | 1.458 |
| TDF | 2,577.67 | 2,236.49 | 1.153 |

In the example of FIG. 10, determining (806) the user rank (320) for that user also includes determining (809) the user rank (320) for that user in dependence upon the average-standard deviation ratio (814) for that user. Determining (809) the user rank (320) for that user in dependence upon the average-standard deviation ratio (814) for that user according to the example of FIG. 10 may be carried out by simply assigning the average-standard deviation ratio (814) for that user as the user rank (320) for that user. Of course, in other embodiments, determining (809) the user rank for that user in dependence upon the average-standard deviation ratio (814) for that user in the example of FIG. 10 may be carried out by scanning all of the average-standard deviation ratios for the lowest value, assigning the user associated with the lowest average-standard deviation ratio the ordinal value of 1, removing that lowest average-standard deviation ratio from the list and repeating the process using the next lowest average-standard deviation ratio and the next higher ordinal value. The process could be repeated until the entire list of average-standard deviation ratios has been exhausted.

As mentioned, the other aspects of FIG. 10 are carried out in the manner described with reference to FIG. 9.

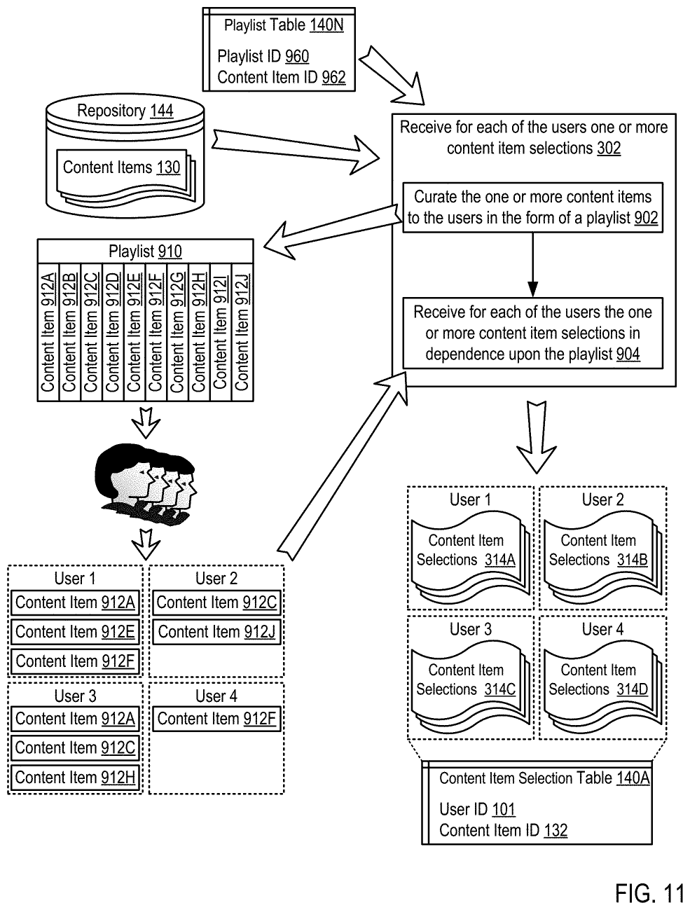

In some embodiment, allowing users to select content items from any source might make comparing the ability of users to forecast popular content items because different users might have access to different content, which could skew the results. As such, providing the users with a contest playlist might be advantageous. For further explanation, FIG. 11 sets forth a flow chart illustrating another exemplary method for receiving (302) for each of the users one or more content item selections (314) according to embodiments of the present invention. Receiving (302) for each of the users one or more content item selections (314) according to embodiments of the present invention according the example of FIG. 11 includes curating (902) various content items (130) to the users in the form of a playlist (910). The playlist (910) of FIG. 11 is a subset of content items (130) selected by the contest administrator or sponsor. The playlist (910) of FIG. 11 is stored in a playlist table (140N), which is one of the tables (140) described with reference to FIG. 2. The playlist table (140N) of FIG. 11 has two fields: playlist ID (960) and content item ID (962). The playlist ID (960) is a unique identifier that represent a particular playlist. The content item ID (962) is a unique identifier that represents a particular content item (130) that is a member of the playlist specified by the playlist ID (960).

In the example of FIG. 11, curating (902) various content items (130) to the users in the form of a playlist (910) may be carried out by scanning the playlist table (140N), retrieving the content item identifiers for the content items included in a particular playlist, and publishing the list of content items for the playlist to users participating in the contest. Curating (902) various content items (130) to the users in the form of a playlist (910) in the example of FIG. 11 may also be carried out by retrieving information about the content items in the playlist from the repository (144) where the content items (130) are stored and providing that information to the users along with the playlist. Such details may include the title, author, hyperlink to, brief description of each content item in the playlist. Curating (902) various content items (130) to the users in the form of a playlist (910) in the example of FIG. 11 may be carried out by publishing the playlist on a website that is accessible to the users, emailing the playlist to the users, or encapsulating a JSON object with the playlist for delivery to a user in response to receiving a web services request through a web services API.

In the example of FIG. 11, playlist (910) is curated to the users and includes content items (912A-J). ‘User 1’ selects content items (912A, 912E, 912F). ‘User 2’ selects content items (912C, 912J). ‘User 3’ selects content items (912A, 912C, 912H). ‘User 4’ selects content item (912F).

In the example of FIG. 11, receiving (302) for each of the users one or more content item selections (314) according to embodiments of the present invention includes receiving (904) for each of the users the one or more content item selections (314) in dependence upon the playlist (910). Receiving (904) for each of the users the one or more content item selections (314) in the example of FIG. 11 may be carried out by receiving a set of selections from each user through a website where the users can add playlist content items to their entry in the contest. Receiving (904) the one or more content item selections (314) in the example of FIG. 11 may also be carried out by receiving each user's playlist content items through web service API calls.

Receiving (904) for each of the users the one or more content item selections (314) in the example of FIG. 11 may further be carried out by associating each user with the content items each user selected. This association may be carried out by storing an identifier for the user and the identifier for each content item selected by that user together in the content item selection table (140A), which includes fields: user ID (101) and content item ID (132), as discussed with reference to FIG. 3. In the example of FIG. 11, the data processing system operating according to embodiments of the present invention receives content item selections (314A) for ‘User 1’, content item selections (314B) for ‘User 2’, content item selections (314C) for ‘User 3’, and content item selections (314D) for ‘User 4’.

To assist users in showcasing their ability to forecast popular content items, systems useful in accordance with embodiments of the present invention may offer users the ability to participate in multiple contests so that users may create a performance track record. This performance track record allows users to demonstrate their forecasting ability to others, thereby gaining trust with the user's audience in their ability to curate good content.

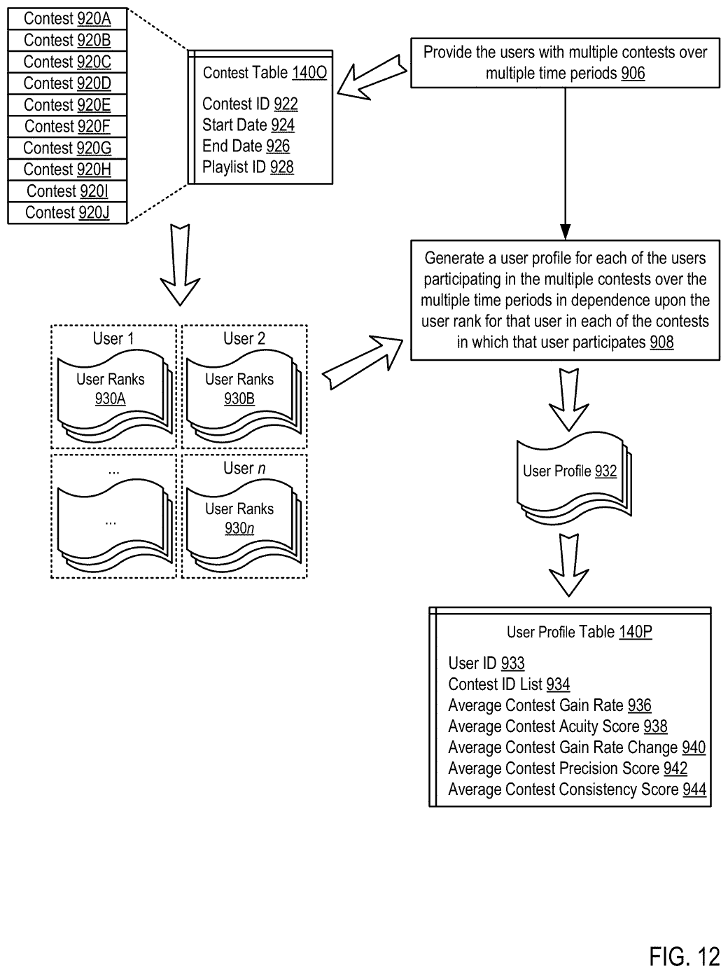

For further explanation, FIG. 12 sets forth a flow chart illustrating an additional exemplary method for identifying the ability of users to forecast popularity of various content items according to embodiments of the present invention. In the example of FIG. 12, a data processing system provides (906) users with multiple contests (920) over multiple time periods. Providing (906) users with multiple contests (920) over multiple time periods in the example of FIG. 12 may be carried out using the systems and processes already described with reference to FIGS. 1-11 over and over again. Each contest may or may not overlap in time period.

In providing (906) users with multiple contests (920) over multiple time periods in the example of FIG. 12, a data processing system stores the contest details in a contest table (1400), which is one of the tables (140) described with reference to FIG. 2. The contest table (1400) of FIG. 12 has four fields: contest ID (922), start date (924), end date (926), and playlist ID (928). Contest ID (922) of FIG. 12 represents a unique identifier for a particular contest. Start date (924) of FIG. 12 represents the date on which a particular contest starts. End date (926) of FIG. 12 represents the date on which a particular contest ends. Playlist ID (928) of FIG. 12 is a unique identifier for the playlist curated to the users for a particular contest. In the example of FIG. 12, the contest table (1400) stores information for multiple contests (920A-J).

In providing (906) users with multiple contests (920) over multiple time periods in the example of FIG. 12, each of the users are ranked according to examples described with reference to FIGS. 3-11. As the contests (920) are conducted over multiple time periods in the example of FIG. 12, ‘User 1’ accumulates user ranks (930A), ‘User 2’ accumulates user ranks (930B), . . . , and ‘User n’ accumulates user ranks (930n).

In the example of FIG. 12, a data processing system generates (908) a user profile (932) for each of the users participating in the multiple contests over the multiple time periods in dependence upon the user rank (930) for that user in each of the contests (920) in which that user participates. Each user profile (932) of FIG. 12 represents a particular user's performance history, which are a collection of the user ranks (930n) for that user over the course of the contests in which that user participated. The user profiles (932) of FIG. 12 are stored in a user profile table (140P), which is one of the tables (140) described with reference to FIG. 2. The user profile table (140P) of FIG. 12 has seven fields: user ID (933), contest ID list (934), average contest gain rate (936), average contest acuity score (938), average contest gain rate change (940), average contest precision score (942), and average contest consistency score (944). User ID (933) of FIG. 12 represents a particular user participating in one of the contests.

Contest ID List (934) of FIG. 12 represents the list of contests in which a particular user participated and may be used to go back to each contest and retrieve the entire performance history of a particular user.

Average contest gain rate (936) of FIG. 12 represents the average gain rate achieved by a user over all of the contests in which the user participates. Average gain rate for a user may be a type of user rank determined for a user as described with reference to FIG. 4. Average contest acuity score (938) of FIG. 12 represents the average user acuity score achieved by a user over all of the contests in which the user participates. User acuity score for a user may be a type of user rank determined for a user as described with reference to FIG. 5. Average contest gain rate change (940) of FIG. 12 represents the average user view county gain rate change achieved by a user over all of the contests in which the user participates. Average user view county gain rate change for a user may be a type of user rank determined for a user as described with reference to FIG. 6. Average contest precision score (942) of FIG. 12 represents the average precision score achieved by a user over all of the contests in which the user participates. The precision score for a user may be a type of user rank determined for a user as described with reference to FIGS. 7 and 8. Average contest consistency score (944) of FIG. 12 represents the average user standard deviation or average-standard deviation ratio achieved by a user over all of the contests in which the user participates. The user standard deviation and average-standard deviation ratio for a user may be a type of user rank determined for a user as described with reference to FIGS. 9 and 10. The user profile table (140P) is provided here for example only and not for limitation. Other metrics or other methods of determining user rank may be contained within a particular user's profile.

Exemplary embodiments of the present invention are described largely in the context of fully functional data processing systems for identifying the ability of users to forecast popularity of various content items according to embodiments of the present invention. Readers of skill in the art will recognize, however, that portions of the present invention also may be embodied in a computer program product disposed on computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, flash storage, magnetoresistive storage, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A system for identifying the ability of users to forecast popularity of various content items, the system comprising:
one or more processing units;
a physical network interface coupled to the one or more processing units; and
a non-volatile memory coupled to the one or more processing units, the non-volatile memory containing a data structure and instructions, the one or more processing units configured to cause execution of the instructions for carrying out:
identifying a time period for a contest over which users compete to identify popular content items,
receiving for each of the users one or more content item selections, each of the content item selections identifying a content item selected by that user as potentially popular,
tracking, over the time period, a view count for the content item identified by each of the content item selections,
determining, for the time period, a view count gain rate for the content item identified by each of the content item selections in dependence upon the view count for that content item,
determining, for each of the users, a user rank in dependence upon the view count gain rate for the content item identified by each of the content item selections received for that user, and
publishing the user rank for at least one of the users.

2. The system of claim 1 wherein determining, for each of the users, a user rank further comprises:
determining a total gain rate for that user by adding together each view count gain rate for each content item selected by that user;
determining an average user gain rate by dividing the total gain rate for that user by the number of content items selected by that user; and
determining the user rank for that user in dependence upon the average user gain rate for that user.

3. The system of claim 1 wherein determining, for each of the users, a user rank further comprises:
determining, for each content item selected by that user, a content acuity score by dividing the view count gain rate for that content item by the number of users that selected that content item for the contest;
determining for that user a user acuity score by dividing a sum of the content acuity score for each content item selected by that user by the number of content item selections received for that user; and
determining the user rank for that user in dependence upon the user acuity score for that user.

4. The system of claim 1 wherein determining, for each of the users, a user rank further comprises:
determining, for each content item selected by that user, a beginning view count gain rate at a start of the time period;
determining, for each content item selected by that user, a view count gain rate change in dependence upon the view count gain rate and the beginning view count gain rate for that content item;
determining an average user view count gain rate change by dividing a sum of the view count gain rate change for each content item selected by that user by the number of content item selections received for that user; and
determining the user rank for that user in dependence upon the average user view count gain rate change for that user.

5. The system of claim 1 wherein determining, for each of the users, a user rank further comprises:
determining, for each content item selected by that user, whether the view count gain rate for that content item satisfies a threshold criteria;
determining a precision score for that user in dependence upon the number of content items selected by that user having the view count gain rate that satisfies the threshold criteria; and
determining the user rank for that user in dependence upon the precision score for that user.

6. The system of claim 5 wherein:
wherein the threshold criteria further comprises a top percentile of all of the view count gain rates determined for the time period;
determining, for each content item selected by that user, whether the view count gain rate for that content item satisfies a threshold criteria further comprises determining whether the view count gain rate for that content item is within the top percentile.

7. The system of claim 1 wherein determining, for each of the users, a user rank further comprises:
determining an average user gain rate for that user by calculating an average of a set that includes each view count gain rate for each content item selected by that user;
determining a user standard deviation for that user by calculating a standard deviation of the set that includes each view count gain rate for each content item selected by that user; and
determining the user rank for that user in dependence upon the average user gain rate and the user standard deviation for that user.

8. The system of claim 7 wherein determining the user rank for that user further comprises:
calculating an average-standard deviation ratio for that user by dividing the average user gain rate by the user standard deviation; and
determining the user rank for that user in dependence upon the average-standard deviation ratio for that user.

9. The system of claim 1 wherein the content items further comprise video content.

10. The system of claim 1 wherein the content items further comprise audio content.

11. The system of claim 1 wherein receiving for each of the users one or more content item selections further comprises:
curating the one or more content items to the users in the form of a playlist; and
receiving for each of the users the one or more content item selections in dependence upon the playlist.

12. The system of claim 1 further comprising:
providing the users with multiple contests over multiple time periods; and
generating a user profile for each of the users participating in the multiple contests over the multiple time periods in dependence upon the user rank for that user in each of the contests in which that user participates.

13. A computer-implemented method for identifying the ability of users to forecast popularity of various content items, the method comprising:
identifying a time period for a contest over which users compete to identify popular content items;
receiving for each of the users one or more content item selections, each of the content item selections identifying a content item selected by that user as potentially popular;
tracking, over the time period, a view count for the content item identified by each of the content item selections;
determining, for the time period, a view count gain rate for the content item identified by each of the content item selections in dependence upon the view count for that content item;
determining, for each of the users, a user rank in dependence upon the view count gain rate for the content item identified by each of the content item selections received for that user; and
publishing the user rank for at least one of the users.

14. The computer-implemented method of claim 13 wherein determining, for each of the users, a user rank further comprises:
determining a total gain rate for that user by adding together each view count gain rate for each content item selected by that user;
determining an average user gain rate by dividing the total gain rate for that user by the number of content items selected by that user; and
determining the user rank for that user in dependence upon the average user gain rate for that user.

15. The computer-implemented method of claim 13 wherein determining, for each of the users, a user rank further comprises:
determining, for each content item selected by that user, a content acuity score by dividing the view count gain rate for that content item by the number of users that selected that content item for the contest;
determining for that user a user acuity score by dividing a sum of the content acuity score for each content item selected by that user by the number of content item selections received for that user; and
determining the user rank for that user in dependence upon the user acuity score for that user.

16. The computer-implemented method of claim 13 wherein determining, for each of the users, a user rank further comprises:
determining, for each content item selected by that user, a beginning view count gain rate at a start of the time period;
determining, for each content item selected by that user, a view count gain rate change in dependence upon the view count gain rate and the beginning view count gain rate for that content item; and
determining an average user view count gain rate change by dividing a sum of the view count gain rate change for each content item selected by that user by the number of content item selections received for that user; and
determining the user rank for that user in dependence upon the average user view count gain rate change for that user.

17. The computer-implemented method of claim 13 wherein determining, for each of the users, a user rank further comprises:
determining, for each content item selected by that user, whether the view count gain rate for that content item satisfies a threshold criteria;
determining a precision score for that user in dependence upon the number of content items selected by that user having the view count gain rate that satisfies the threshold criteria; and
determining the user rank for that user in dependence upon the precision score for that user.

18. The computer-implemented method of claim 13 wherein determining, for each of the users, a user rank further comprises:
determining an average user gain rate for that user by calculating an average of a set that includes each view count gain rate for each content item selected by that user;
determining a user standard deviation for that user by calculating a standard deviation of the set that includes each view count gain rate for each content item selected by that user; and
determining the user rank for that user in dependence upon the average user gain rate and the user standard deviation for that user.

19. The computer-implemented method of claim 18 wherein determining, for each of the users, a user rank further comprises:
calculating an average-standard deviation ratio for that user by dividing the average user gain rate by the user standard deviation; and
determining the user rank for that user in dependence upon the average-standard deviation ratio for that user.

20. The computer-implemented method of claim 13 wherein receiving for each of the users one or more content item selections further comprises:
curating the one or more content items to the users in the form of a playlist; and
receiving for each of the users the one or more content item selections in dependence upon the playlist.
